(19) United States
(12) Patent Application Publication
(10) Pub. No.: US 2025/0067207 A1
(43) Pub. Date: Feb. 27, 2025

(54) INTERNAL COMBUSTION ENGINE SYSTEM

(71) Applicant: VOLVO TRUCK CORPORATION, GÖTEBORG (SE)

(72) Inventors: Fredrik Larsson, VELLINGE (SE); Fredrik Rahm, HÖRBY (SE)

(21) Appl. No.: 18/776,784

(22) Filed: Jul. 18, 2024

(30) Foreign Application Priority Data
Aug. 22, 2023 (EP) 23192660.1

(51) Int. Cl. F02B 25/02; F02B 75/02; F02B 75/18; F02D 13/02

(52) U.S. Cl. CPC F02B 25/02; F02B 75/02; F02B 75/18; F02D 13/0223; F02B 2075/025; F02B 2075/1808

(57) ABSTRACT

An internal combustion engine (ICE) system for a vehicle, the ICE system including: a two-stroke ICE operable on a fuel, the ICE having at least one cylinder with a cylinder wall and further a reciprocating piston moveable in an axial direction within the cylinder between a bottom dead center (BDC) and a top dead center (TDC), the piston extending in the axial direction and having an axial upper part with a top end intended to form part of a combustion chamber. The ICE system further includes an axial lower part, the at least one cylinder at least partly defining the combustion chamber with the top end of the piston. The at least one cylinder including at least one intake port arranged at a top end of the at least one cylinder and in fluid communication with the combustion chamber.

### CROSS REFERENCE TO RELATED APPLICATION

This application claims foreign priority to European Application 23192660.1 filed on Aug. 22, 2023, the disclosure and content of which is incorporated by reference herein in its entirety.

### TECHNICAL FIELD

The disclosure relates generally to an internal combustion engine system. The disclosure can be applied to heavy-duty vehicles, such as trucks, buses, and construction equipment, among other vehicle types. Although the disclosure may be described with respect to a truck, the disclosure is not restricted to any particular vehicle. The internal combustion engine system may e.g. be applicable for other types of vehicles propelled by means of an internal combustion engine such as cars and other light-weight and light-duty vehicles etc. Further, the internal combustion engine of the internal combustion engine system may typically be an internal combustion engine operable on a hydrogen-based fuel.

### BACKGROUND

To reduce negative climate effects there is an increasing interest in reducing the use of fossil fuels. By way of example, reduction of exhaust gases, increasing engine efficiency, i.e. reduced fuel consumption, and lower noise level from the engines are some of the criteria that have become more important aspects when designing and selecting a suitable internal combustion engine (ICE) system and its engine component. Furthermore, in the field of heavy-duty vehicles, such as trucks, there are a number of prevailing environmental regulations that set specific requirements on the vehicles, e.g. restrictions relating to maximum allowable amount of exhaust gas pollution.

One possibility is to use hydrogen gas, produced in a fossil-free way, as fuel in internal combustion engines instead of using e.g. fossil-based diesel. The huge amount of conventional, already existing, diesel engines cannot operate properly if simply just fed with hydrogen instead of diesel; these engines must be adapted before being capable of using hydrogen fuel. However, to make such adaptation of existing diesel engines economically feasible, it is necessary that the adaptations are not too complex and costly. Examples of various ICE systems with piston and piston rings are disclosed in U.S. Pat. Nos. 2,132,223 A, 2,096,327 A, 4,016,839A, 4,399,778 A and 9,441,573B1.

### SUMMARY

According to a first aspect of the disclosure, there is provided an internal combustion engine (ICE) system for a vehicle. The ICE system comprises a two-stroke ICE operable on a fuel. The ICE has at least one cylinder with a cylinder wall and further a reciprocating piston moveable in an axial direction within the cylinder between a bottom dead center (BDC) and a top dead center (TDC). The piston extends in the axial direction. Moreover, the piston has an axial upper part with a top end intended to form part of a combustion chamber, and further an axial lower part. The at least one cylinder at least partly defines the combustion chamber with the top end of the piston. The at least one cylinder comprises at least one intake port arranged at a top end of the at least one cylinder. The at least one intake port is in fluid communication with the combustion chamber. Moreover, the at least one cylinder comprises an exhaust port arranged axially distal from the top end of the at least one cylinder, allowing the at least one intake port and the exhaust port to be fluidly separated by the piston. Further, the axial upper part of the piston comprises a number of compression rings for sealing of the combustion chamber and the axial lower part comprises at least one compression ring configured to seal along a region of the cylinder wall axially below the exhaust port, so as to reduce leakage of blow by gases from the combustion chamber into a crankcase volume part of the ICE.

The first aspect of the disclosure may seek to provide an improved two-stroke ICE system in terms of a more reliable and stable combustion of fuel. In particular, the disclosure may seek to provide an ICE system allowing for a more stable combustion of fuel such as a hydrogen-based fuels. A technical benefit may include a more efficient transfer of exhaust gases from the combustion chamber to the exhaust system in that the blow by gases are allowed to escape through the exhaust port, thus reducing the risk of having blow by gases into the crankcase volume. More specifically, the arrangement of the at least one compression ring at the axial lower part of the piston provides for limiting the pressure above the at least one compression ring to pass downwards into the crankcase volume part of the crankcase. The arrangement of the compression ring(s) at the axial upper part in combination with the at least one compression ring at the axial lower part provides for directing gases that have passed the compression ring(s) at the axial upper part through the exhaust port, while preventing, or at least reducing, gases to return to the combustion chamber through the exhaust port when the compression ring(s) at the axial upper part is/are above the exhaust port. By the arrangement of the piston in the cylinder, it becomes possible to reduce the risk of having soot and oil particles mixed into the combustion process.

By the provision of arranging the respective intake port and exhaust port of the cylinders at different positions, the corresponding piston will provide for a blocking effect between the intake and exhaust ports when the piston is in its top dead center, so that the hot part of the cylinder (exhaust port and cylinder wall/liner) will be entirely separated from the combustible gas (generally corresponding to an air/fuel mixture).

As such, the proposed ICE system enables a length-scavenging system that separates the hot exhaust end of the cylinder from the cold intake end where the combustibles are present. Therefore, the knock risk may be drastically reduced with the proposed ICE system. To this end, the proposed ICE system provides for suppressing the tendency for knock and/or self-ignition of the fuel, such as a gaseous fuel, e.g. hydrogen-based fuel.

In addition, the proposed two-stroke ICE, favorably operable on hydrogen, or any other gaseous fuel, provides for increasing the BMEP potential due to twice the firing frequency. In particular, the two-stroke cycle enable the ICE to operate at a higher lambda with a maintained power density, as compared to four stroke ICEs.

A “two-stroke operation” or “two-stroke mode” refers to a cycle of the internal combustion engine, in which the piston moves two strokes (up and down movements) between the TDC and the BDC during only one crank shaft revolution so as to complete a full work cycle. In general, the operation of the internal combustion engine when operated in a general two-stroke operation corresponds to a repetitive engine operation every crank shaft revolution.

The fuel may be a gaseous fuel, a liquid fuel or a combination thereof, e.g. a dual fuel having a first fuel and a second fuel.

The blow by gases may generally contain combustible fuel as well as exhaust residuals.

By the provision of arranging the exhaust port axially distal from the top end of the at least one cylinder, allowing the at least one intake port and the exhaust port to be fluidly separated by the piston, the at least one intake port and the exhaust port are located at different positions and fluidly separated by the piston top end when the piston is in the upper part of the cylinder. In particular, the at least one intake port and the exhaust port are located at different positions and fluidly separated by the piston top end when the piston is in its top dead center. As such, the fluid communication between the combustion chamber and the exhaust port is controlled by a position of the piston, typically corresponding to an axial position of the piston along the axial direction.

Typically, the crankcase volume part may be arranged axially below the exhaust port. In addition, or alternatively, the crankcase volume may be arranged axially below the piston at its BDC.

In some examples, including in at least one preferred example, optionally the at least one compression ring of the axial lower part and a compression ring of the number of compression rings of the axial upper part are arranged on the piston to provide an intermediate ring land where blow by gases can be trapped and evacuated through the exhaust port. A technical benefit of the intermediate ring land may be to provide an improved scavenging process in terms of evacuating the blow by gases through the exhaust port. In other words, the intermediate land ring further contributes to directing gases that have passed the compression ring(s) at the axial upper part through the exhaust port, while preventing, or at least reducing, gases to return to the combustion chamber through the exhaust port when the compression ring(s) at the axial upper part is/are above the exhaust port.

In some examples, including in at least one preferred example, optionally the at least one compression ring of the axial lower part may be arranged on the piston such that a position of the at least one compression ring is axially below the exhaust port at the TDC of the piston. Accordingly, the at least one compression ring of the axial lower part may be arranged on the piston such that a position of the at least one compression ring is never positioned above a lower end of the exhaust port at the TDC of the piston.

In some examples, including in at least one preferred example, optionally the number of compression rings of the axial upper part may be arranged on the piston such that a position of the number of compression rings is axially below the exhaust port at the BDC of the piston. This arrangement further contributes to separating any crankcase gases and lubricating oil from the combustion gases and blow-by gases.

In some examples, including in at least one preferred example, optionally the number of compression rings of the axial upper part comprises at least two compression rings. A technical benefit may include an improved sealing between the combustion chamber and the exhaust port during the combustion process.

In some examples, including in at least one preferred example, optionally the axial lower part of the piston comprises an oil control ring arranged axially below the at least one compression ring at the axial lower part of the piston. The oil control ring is configured to distribute oil during movement of the piston along the cylinder wall. A technical benefit may include an improved lubrication between the piston and the cylinder wall at the lower parts of the cylinder wall, i.e. below the position of the exhaust port. Moreover, the arrangement of the oil control ring in the ICE system allows for reducing oil in the combustibles from the cylinder wall, that can create autoignition.

In some examples, including in at least one preferred example, optionally any one of the compression rings is defined by a homogenous rectangular cross-section or a tapered cross-section.

In some examples, including in at least one preferred example, optionally the at least one compression ring of the axial lower part is a Napier-type compression ring. The use of a Napier-type compression ring in the ICE system allows for providing a reliable leakage reduction of blow by gases along the region of the cylinder wall axially below the exhaust port. The use of a Napier-type compression ring may further have a positive impact on the overall oil consumption in comparison to other types of compression rings.

In some examples, including in at least one preferred example, optionally the axial lower part of the piston comprises the at least one compression ring, an additional compression ring in the form of a Napier-type compression ring, the Napier-type compression ring being arranged axially below the at least one compression ring, and further an oil control ring, the oil control ring being arranged axially below the Napier-type compression ring.

In some examples, including in at least one preferred example, optionally the at least one compression ring of the axial lower part is arranged in a groove extending circumferentially around the piston skirt. It should be noted that any one of the compressions rings, oil control rings and any other ring may generally be arranged in a corresponding groove extending about the piston in the circumferential direction.

The piston defines an envelope surface extending in the axial direction and circumferential direction, with an upper region at the upper part and a lower region at the lower part, the upper region having the upper ring pack with one or more compression rings, while the lower region having the corresponding lower ring pack.

The compression rings generally extend in the circumferential direction about the piston.

Further, the ICE system is a spark-ignition ICE system, the at least one cylinder having an ignition source arranged in the combustion chamber.

In some examples, including in at least one preferred example, optionally the ICE system comprises an injector arrangement for injecting fuel, the injector arrangement being arranged in the combustion chamber.

In some examples, including in at least one preferred example, optionally the flow of intake gas though the at least one intake port is controllable by an intake control valve.

In some examples, including in at least one preferred example, optionally the at least one cylinder is a first cylinder and the piston is a first piston, and the ICE further having a second cylinder forming a pair of cylinders with the first cylinder, the second cylinder accommodating a corresponding reciprocating second piston operable between a bottom dead center and a top dead center, and further at least partly defining a second combustion chamber with a top end of the second piston, wherein the second cylinder further comprises a corresponding ignition source arranged in the second combustion chamber, at least one corresponding intake port arranged at a top end of the second cylinder and in fluid communication with the second combustion chamber, and further a corresponding exhaust port arranged axially distal from the top end of the second cylinder, allowing the at least one corresponding intake port and the corresponding exhaust port to be fluidly separated by the piston.

In some examples, including in at least one preferred example, optionally the first and second cylinders may be separated from each other with a crank angle of 180 degrees.

By the provision of having the pair of first and second cylinders arranged separated from each other with a crank angle of 180 degrees, the two cylinders can provide a 180 degrees cycle separation irrespectively of the ICE and cylinder arrangement/configuration.

In some examples, including in at least one preferred example, optionally the pair of first and second cylinders may be arranged separated from each other with a crank angle of 180 degrees, so as to provide a 180 degrees combustion phasing separation.

In some examples, including in at least one preferred example, optionally the ICE system further comprises an air intake duct having a positive displacement device configured to receive and feed intake air to the at least one pair of cylinders, the positive displacement device further being arranged in the air intake duct to separate an upstream intake tract from a downstream plenum of the air intake duct, the downstream plenum being in fluid communication with each one of the first and second cylinders of the at least one pair of cylinders. By the arrangement of the positive displacement device in the air intake duct, the displacement device is arranged to eliminate, or at least reduce, the risk of having pressure pulses transferred backwards from the combustion chambers to the upstream intake tract of the air intake duct. As such, the intake ports are mechanically isolated from the intake tract. The positive displacement device is thus arranged to seal the cylinders and the downstream intake plenum from the upstream intake tract of the air intake duct (intake manifold) in case of backfire. Also, by the arrangement and configuration of the displacement device in the air intake duct, the displacement device can still provide an even flow by the alternating feed to the cylinder pair.

To this end, the ICE system may thus provide separate intake plenum for each pair of cylinders with a 180 degrees combustion phasing separation, where the intake duct has a close coupled positive displacement device for each pair of cylinders. Such ICE system may contribute to reducing time-to-ignition with decreased risk of having backfiring into the induction system of the ICE system.

It should be noted that the proposed ICE system may not be restricted to a system with one single pair of cylinders, but can also be implemented in four cylinders, six cylinders etc. Hence, the proposed ICE system may have a minimum of two cylinders, but multiples of two cylinders may be possible.

In some examples, including in at least one preferred example, optionally the intake control valve of the first cylinder is controllable in correlation with the movement of the first piston and the intake control valve of the second cylinder is controllable in correlation with the movement of the second piston such that fluid communication between the respective combustion chambers and the downstream plenum being selectively opened and closed during a crank shaft revolution of the ICE.

In some examples, including in at least one preferred example, optionally the plenum may comprise an air inlet configured to be in fluid communication with the positive displacement device and a plurality of outlets configured to be in fluid communication with the intake ports of the first and second cylinders.

In some examples, including in at least one preferred example, optionally the ICE system may comprise a common crankcase housing for the pair of cylinders, or, the ICE system may comprise multiple set of pair of cylinders and the ICE system comprises a common crankcase housing for all cylinders of the ICE.

Moreover, the ICE system is a hydrogen ICE system configured to operate on a gaseous fuel containing a hydrogen-based gaseous fuel.

The ICE system may be beneficial for all force scavenged two strokes ICE systems, including, but not limited to compression ignited fuel engines, for example H2 ICE systems with diesel pilot injection in a two-stroke mode.

In some examples, including in at least one preferred example, optionally the fuel may be a gaseous fuel. One example of a gaseous fuel is a hydrogen-based fuel.

In some examples, including in at least one preferred example, optionally the fuel is a liquid fuel. One example of a liquid fuel is an NH3-based fuel.

In some examples, including in at least one preferred example, optionally the ignition source may be any one of a spark plug and a glow plug.

In some examples, including in at least one preferred example, optionally each one of the intake control valve and the corresponding intake control valve may be arranged to open and close a fluid passage of the respective intake port, thus controlling the flow of fluid to the respective combustion chamber.

In some examples, including in at least one preferred example, optionally the ICE system may comprise a fuel injector arrangement arranged in the downstream plenum of the air intake duct so as to provide a fuel injection upstream the intake ports of the first and second cylinders. A technical benefit may include an improved injection of fuel into the combustion chamber(s) of the ICE. Hereby, the ICE system is configured to provide port injection of the gaseous fuel or the liquid fuel.

The use of a port injection allows for providing a homogenous mixture which enables an improved knock and auto-ignition control and also contributes to reduce the emissions.

Alternatively, the fuel injector arrangement may be arranged in each one of the combustion chambers of the first and second cylinders, respectively.

In some examples, including in at least one preferred example, optionally the fuel injector arrangement may be controllable to inject fuel to the intake port and the corresponding intake port such that pressure pulses are generated in the downstream plenum and subsequently travel into the corresponding combustion chambers. A technical benefit may include an improved scavenging effect. As such, the ICE system is configured to provide a scavenging effect by the injection timing in the intake port(s). The fuel injector arrangement may generally be controllable in response to a predetermined fuel injection event.

In some examples, including in at least one preferred example, optionally the fuel injector arrangement may be controllable to provide a sequential injection of fuel to the first and second cylinders so as to allow for active cylinder scavenging during a latter part of a corresponding intake stroke of a corresponding cylinder of the first and second cylinders.

In some examples, including in at least one preferred example, optionally the intake control valve of the first cylinder may be controllable in correlation with the movement of the first piston and the intake control valve of the second cylinder may be controllable in correlation with the movement of the second piston such that fluid communication between the respective combustion chambers and the plenum being selectively open and closed during a crank shaft revolution of the ICE. A technical benefit may include to further reduce the risk of backfire.

In some examples, including in at least one preferred example, optionally the plenum may comprise an air inlet in fluid communication with the positive displacement device and a plurality of outlets configured to be in fluid communication with the intake ports of the first and second cylinders. A technical benefit may include an improved air supply system for supplying air to the cylinders. By way of example, the plenum is a Siamese-shaped design.

In some examples, each one of the cylinder heads of the first and second cylinders may have a plurality of intake control valves. The number of intake control valves for each cylinder can generally be any practical number and may generally be selected based on cylinder type and ICE type. By way of example, each one of the cylinder heads may have a number of four intake control valves. A technical benefit may include an even more improved air supply system for supplying air to the cylinders. A configuration with an ICE system having four intake control valves for each cylinder may be particularly beneficial for two-stroke operated ICE systems that may typically have a shorter intake period that four stroke ICE system. A configuration with an ICE system having four intake control valves for each cylinder allows for increasing the air intake rate into the combustion chamber of the cylinder. In addition, it may improve the scavenging phase expelling (pushing out) the exhaust in a uniform, pressure wave, manner.

In some examples, including in at least one preferred example, optionally the intake control valves may be configured to provide variable valve actuation. A technical benefit may include an improved control of the air supply system for supplying air to the cylinders during operation of the ICE system. Variable valve actuation may also allow for tuning the phasing (valve timing) for a more optimum pulse capture and efficiency in synchronization with the fuel injection and the corresponding pulse in the plenum.

In some examples, including in at least one preferred example, optionally the positive displacement device may be a variable positive displacement device configured to be operated in a variable manner. A technical benefit may include an improved control of the flow and/or pressure of air to the cylinders during operation of the ICE system. Moreover, a variable driven positive displacement device allows for a higher flexibility of the air intake system of the ICE system and also an improved function of the ICE system on a general level.

In some examples, including in at least one preferred example, optionally the pair of first and second cylinders are arranged as a pair of neighboring cylinders. In this manner, the volumetric efficiency of the ICE system may further be improved.

In some examples, including in at least one preferred example, optionally the ICE system may further comprise additional pairs of cylinders with corresponding air intakes duct and positive displacement devices.

In some examples, including in at least one preferred example, optionally the exhaust ports may be arranged in fluid communication with an exhaust duct arranged to transport exhaust gas away from the cylinders.

In some examples, including in at least one preferred example, optionally the ICE system may further comprise a turbocharger arrangement having a turbocharger turbine operatively connected to a turbocharger compressor, wherein the turbocharger compressor is arranged in an air intake conduit to the air intake duct, and wherein the turbocharger turbine is arranged in the exhaust duct so as to drive the turbocharger compressor.

In some examples, including in at least one preferred example, optionally the ICE system may further comprise an exhaust gas recirculation EGR system comprising an EGR conduit arranged to connect the exhaust duct and the air intake duct so as to permit recirculation of exhaust gas through the cylinders during operation of the ICE.

In some examples, including in at least one preferred example, optionally the EGR system may further comprise a corresponding positive displacement device.

In some examples, including in at least one preferred example, optionally the EGR conduit may connect to the air intake conduit at a position downstream the turbocharger compressor and further connects to the exhaust duct at a position upstream the turbocharger turbine.

In some examples, including in at least one preferred example, optionally the ICE system may be a hydrogen ICE system configured to operate on a gaseous fuel containing a hydrogen-based gaseous fuel. Accordingly, the proposed ICE system may be particularly useful for hydrogen ICE systems. Hydrogen-based fuel may generally have a high auto-ignition temperature, however, low ignition energy may only be needed if a spark (or glowing surface or particle) is present. The low ignition energy may, however, pose some challenges on the ICE, e.g. it may be difficult to use a cylinder head where the hot exhaust ports/valves are located in the same combustion chamber as the intake ports/valves or in the vicinity of the compressed air/fuel mixture prior to ignition. A technical benefit of the proposed ICE system for use with a hydrogen-based fuel may include a more reliable and robust hydrogen ICE system.

In some examples, including in at least one preferred example, optionally the ICE system may be configured to collectively control the positive displacement device and the intake valves so as to control flow of gas to the combustion chambers. The positive displacement device and the intake valves may be controllable by a controller. In addition, or alternatively, the positive displacement device may be controllable by a controller and the intake valves may be controllable by one or more camshafts and/or the intake valves may be controllable by one or more corresponding actuators of the intake valves.

In some examples, including in at least one preferred example, optionally the ICE system may further comprise a controller configured to terminate fuel injection during an intake phase and before an intake valve closure, whereby the remaining part of the intake phase comprises emptying the plenum of fuel and subsequently introducing fresh air to the plenum by operating the positive displacement device.

In some examples, including in at least one preferred example, optionally the ICE system may comprise a multiple set of pair of cylinders having corresponding air intake ducts with corresponding positive displacement devices.

According to a second aspect of the disclosure, there is provided a vehicle comprising an internal combustion engine system according to the first aspect and/or according to any one of the examples of the first aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary embodiment of the present disclosure, comprising a side view of a vehicle, in the form of a truck, according to an example.

FIG. 2a shows an internal combustion engine system, according to an example.

FIG. 2b shows an internal combustion engine system, according to an example.

FIG. 2c shows an internal combustion engine system, according to an example.

FIG. 3 shows a cross sectional view of a compression ring of a piston for an internal combustion engine system, according to an example.

FIGS. 4A to 4D shows an example of a combustion cycle of the internal combustion engine system in FIG. 2a to 2c.

### DETAILED DESCRIPTION

The detailed description set forth below provides information and examples of the disclosed technology with sufficient detail to enable those skilled in the art to practice the disclosure.

The disclosure may seek to provide an improved two-stroke ICE system in terms of a more reliable and stable combustion of fuel. A technical benefit may include a more efficient transfer of exhaust gases from the combustion chamber to the exhaust system in that blow by gases are allowed to more directly escape through an exhaust port of the ICE system, thus reducing the risk of having blow by gases into the crankcase volume. Moreover, the proposed ICE system allows for reducing oil in the combustibles from the cylinder wall.

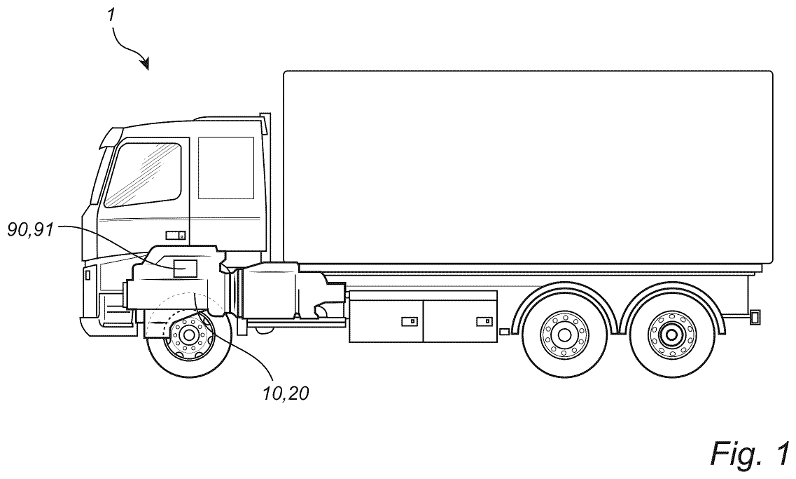

FIG. 1 is an exemplary embodiment of the present disclosure, comprising a side view of a vehicle 1, in the form of a truck, according to an example.

Whilst the shown embodiment illustrates a truck, the disclosure may relate to any vehicle, such as a car, bus, industrial vehicle, boat, ship, etc., wherein motive power may be derived from an internal combustion engine.

The vehicle 1 comprises an internal combustion engine system 10. The internal combustion engine system may generally herein refer to the ICE system 10. Moreover, the vehicle 1 may also comprise a controller 90. The controller is here part of a control system. The controller 90 may be part of the ECU of the vehicle 1. The controller 90 comprises a processing circuitry 91 configured to control the ICE system 10, as described herein.

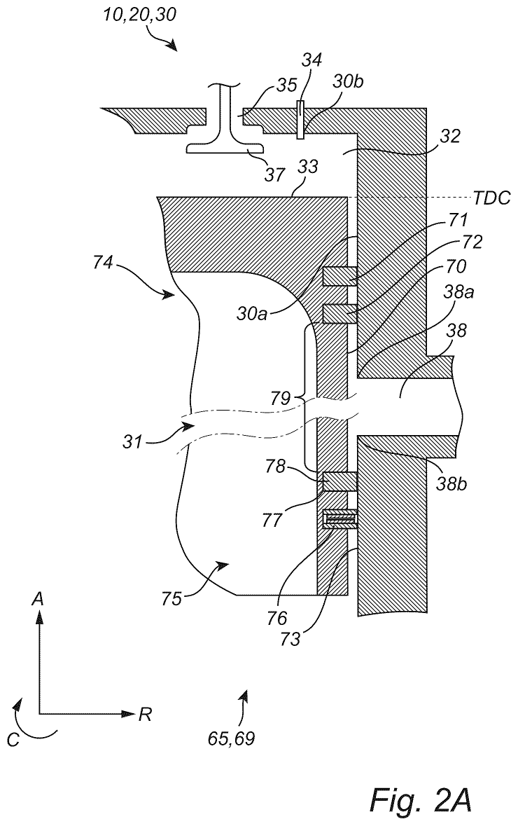

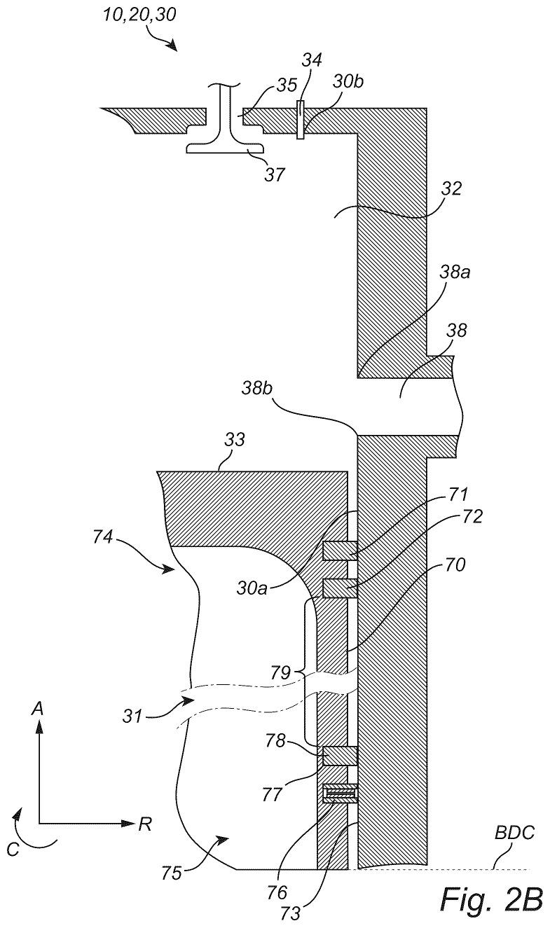

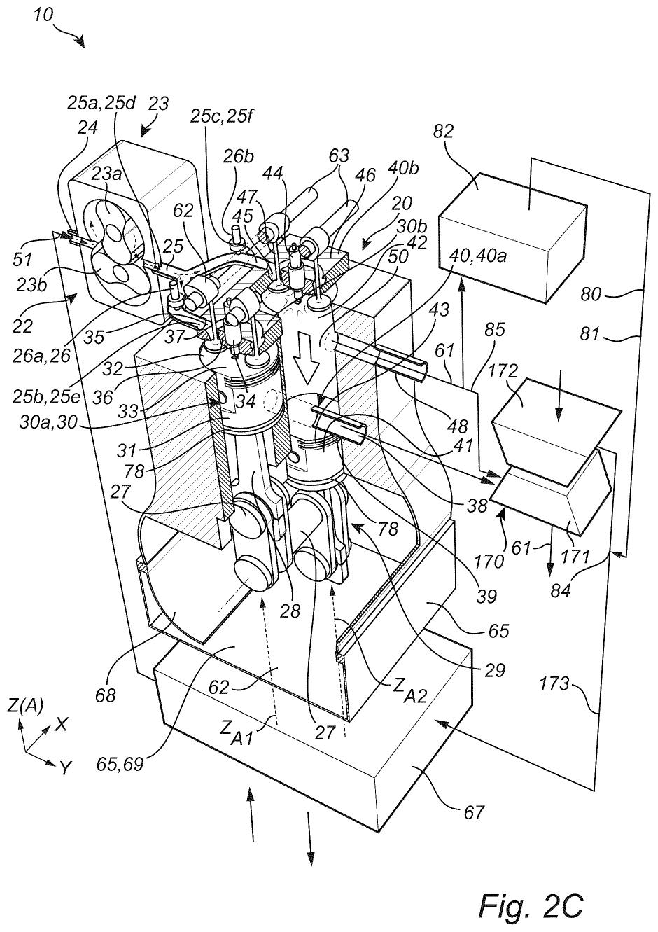

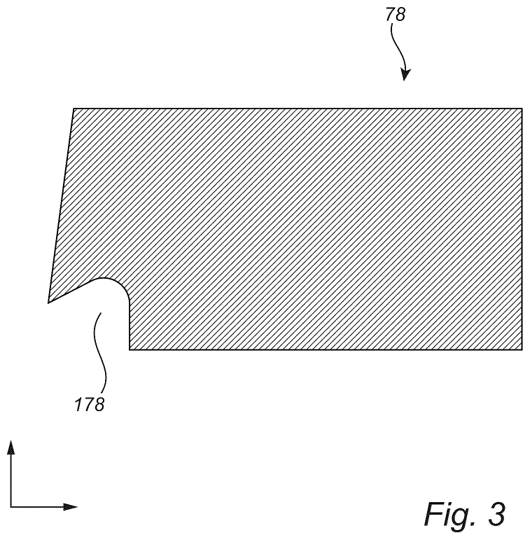

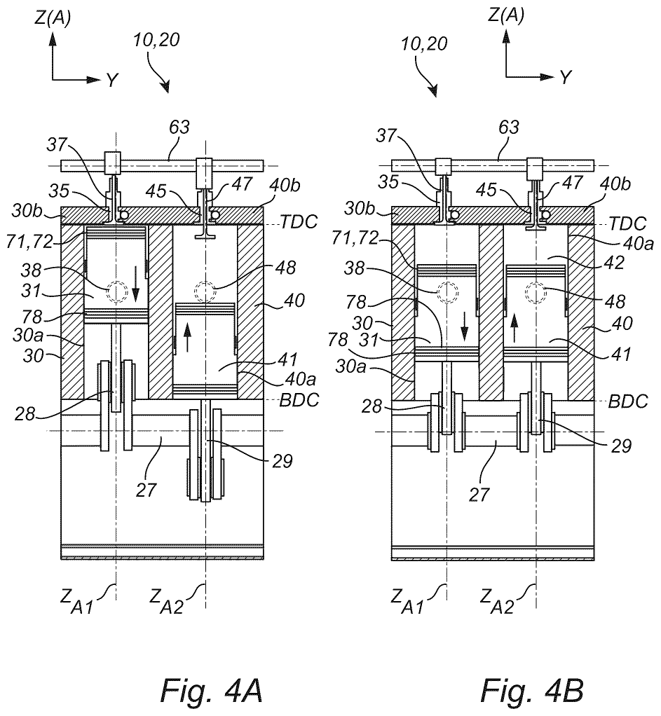

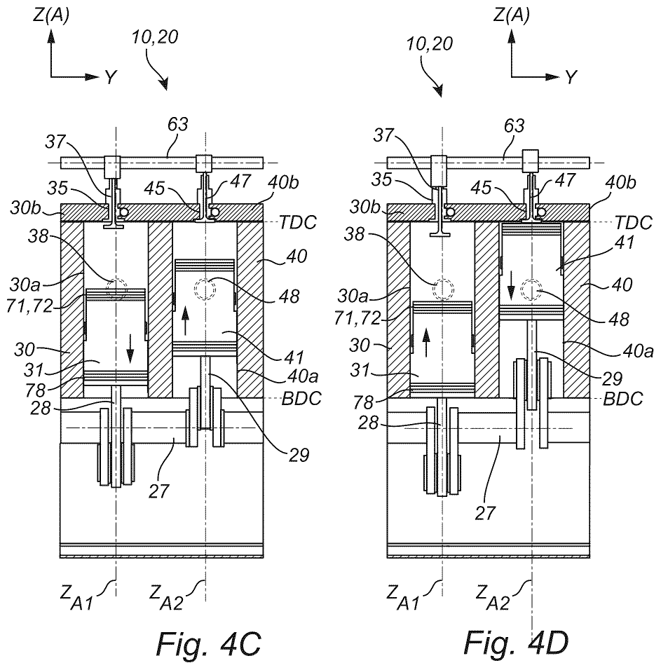

The ICE system 10 will hereinafter be described in relation to FIGS. 2a to 2c, illustrating an example of an ICE system. Further details of the ICE system will be described in relation to FIG. 3 and FIGS. 4A to 4D. More specifically,

FIGS. 2a to 2b show an example of an ICE system 10. Purely by way of example, the FIGS. 2a to 2c of the ICE system 10 may be used in the vehicle 1 of FIG. 1.

The ICE system 10 comprises a two-stroke ICE 20. The ICE 20 is here operable on a gaseous fuel 50. The ICE 20 may in other examples be operable on a liquid fuel. One example of a gaseous fuel is a hydrogen-based fuel. One example of a liquid fuel is an NH3-based fuel. Other examples of liquid fuels are LNG, LPG, petrol, and the like.

FIG. 2c shows further details of the ICE system 10 as illustrated in FIGS. 2a to 2b. The further details in FIG. 2c are provided to describe optional features of the ICE system. Hence, the ICE system 10 as described in relation to FIGS. 2a to 2b may be implemented in any type of two-stroke ICE 12.

Turning now again to FIGS. 2a and 2b, there is illustrated an example of the ICE 20 having at least one cylinder 30 with a cylinder wall 30a. Typically, the at least one cylinder is a first cylinder 30 of the ICE 20. Hence, the ICE 20 comprises at least the first cylinder 30. However, the ICE 20 may typically comprise a number of cylinders, such as a pair of first and second cylinders, as described in relation to FIG. 2c, or a multiple number of pair of cylinders. The cylinder 30 extends in an axial direction A and in a radial direction R. The cylinder 30 also has an extension in a circumferential direction C.

Thus, the cylinder wall 30a extends in the axial direction A and in the circumferential direction C. The cylinder wall 30a is an inner wall of the cylinder 30. In addition, the inner wall of the cylinder may be provided by a so called a cylinder liner, as is commonly known in the art. The cylinder wall 30a may thus be part of a cylinder liner.

The cylinder 30 here also comprises a cylinder head 30b. The cylinder head 30b here defines an uppermost portion of the cylinder 30, as seen in the axial direction A.

By way of example, the cylinder head 30b may have an essentially flat bottom inner surface. Other examples of cylinder heads are also possible. The design of the combustion chamber may thus be provided in several different ways in view of the design of the cylinder head 30b. Hence, the design of the cylinder head and the cylinder in the figures are only provided for illustrating one example of the cylinder design.

The ICE 20 further comprises a reciprocating piston 31. The reciprocating piston 31 is moveable in the axial direction A within the cylinder 30. The reciprocating piston 31 is moveable in an axial direction A within the cylinder 30 between the bottom dead center (BDC) and the top dead center (TDC). The reciprocating piston 31 may in the following be denoted simply as the piston for ease of reference.

FIG. 2a is a cross-sectional view of the piston 31, which is arranged within the cylinder 30. FIG. 2a illustrates the reciprocating piston 31 in its top dead center (TDC). FIG. 2b is another cross-sectional view of the piston 31 arranged within the cylinder 30. FIG. 2b illustrates the reciprocating piston 31 in its bottom dead center (BDC).

The piston 31 extends in the axial direction A and in the radial direction R. The piston 31 has a diameter that is less than an inner diameter of the cylinder 30, as shown in FIG. 2. Further, the piston 31 has a circumferential extension along the circumferential direction C. The piston 31 also has a longitudinal center axis ZA1 (see FIG. 2c), which hereinafter may generally be denoted as the axial center axis.

As used herein, the terms “radial” or “radially” refer to the relative direction that is substantially perpendicular to an axial centerline of a particular component. Further, the term “longitudinal”, “longitudinally”, “axially” or “axial” refer to the relative direction that is substantially parallel and/or coaxially aligned to an axial centerline of a particular component. Also, the term “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction.

Similarly, terms such as “upper”, “above” and “top” as well as “lower”, “bottom”, “below” generally refer to the relative position of the part or component with respect to the axial direction A.

Also, the piston 31 extends in the axial direction A. In addition, the piston 31 further extends in the circumferential direction. To this end, the piston 31 comprises an envelope surface extending in the axial direction A and in the circumferential direction C.

Moreover, the piston 31 comprises an axial upper part 74. The axial upper part 74 here refers to the part forming the piston crown. In other words, the axial upper part 74 is generally the piston crown of the piston 31. The axial upper part 74 comprises a top end 33. The top end 33 is intended to form part of a combustion chamber 32. The top end 33 is here the piston head. In other words, the piston 31 has top end 33 in the form of the piston head.

Further the piston 31 comprises an axial lower part 75. The axial lower part 75 is arranged axially below the axial upper part 74.

In this example, the axial upper part 74 and the axial lower part 75 are parts of a single piece piston. However, the piston may also be a multiple piece piston comprising separate parts together forming the piston. The multiple pieces of the piston can be made of the same material, or be made of different materials.

The axial upper part 74 and the axial lower part 75 are opposite parts of the piston 31, as illustrated in FIG. 2a. More specifically, the axial upper part 74 and the axial lower part 75 are opposite parts of the piston 31, as seen in the axial direction A of the piston 31.

The piston 31 here generally also comprises a piston skirt 70 extending in the axial direction A. The piston skirt 70 further extends in the circumferential direction C of the piston 31. The piston skirt 70 defines an envelope surface extending in the axial direction and circumferential direction.

Accordingly, the piston skirt 70 is also divided into an upper region located at the axial upper part 74 and a lower region at the axial lower part 75.

The at least one cylinder 30 partly defines the combustion chamber 32 with the top end 33 (piston head) of the piston 31. That is, the at least one cylinder 30 partly defines the combustion chamber 32 with the piston head of the piston crown. The combustion chamber 32 is arranged at the end portion, i.e. the cylinder head 30b, of the cylinder 30 so that an upper surface of the top end 33 defines a lower side of the combustion chamber 32. The upper surface of the top end 33 of the axial upper part 74 may, as described herein, refer to the piston head of the piston crown.

The cylinder 30 here further comprises an ignition source 34. The ignition source 34 is arranged in first combustion chamber 32. The ignition source 34 is arranged in the cylinder 30 and at a location facing the combustion chamber 32. By way of example, the ignition source 34 is arranged at an upper end of the cylinder 30, as illustrated in FIG. 2a. In particular, the ignition source 34 is arranged at the cylinder head 30b of the cylinder 30. Other arrangements of the ignition source are also conceivable. The ignition source 34 is configured to ignite e.g. injected hydrogen gas supplied via a fuel arrangement, as described herein. By way of example, the ignition source is a sparkplug. A spark plug is a device for delivering electric current from an ignition system to the combustion chamber of a spark-ignition engine to ignite the compressed fuel/air mixture by an electric spark, while containing combustion pressure within the engine.

It should be noted that the ICE system 10 is not limited to spark-plug ICE system, but can be applied in other type of ICE systems based on diffusion combustion cycles.

Moreover, the at least one cylinder 30 comprises at least one intake port 35 arranged at a top end 36 of the at least one cylinder 30. The top end 36 is here an integral part of the cylinder head 30b.

The intake port 35 is configured to be arranged in fluid communication with the combustion chamber 32.

Moreover, the flow of combustible gas through the at least one intake port 35 is controllable by an intake control valve 37. In this example, the combustible gas may generally contain a mix of air and port injected hydrogen gas (the gaseous fuel). The intake control valve 37 is arranged to open and close a fluid passage of the intake port 35, thus controlling the flow of fluid to the combustion chamber 32.

Further, the at least one cylinder 30 comprises an exhaust port 38 arranged axially distal from the top end 36 of the at least one cylinder 30, allowing the at least one intake port 35 and the exhaust port 38 to be fluidly separated by the piston 31.

Accordingly, the intake port 35 and the exhaust port 38 are located at different positions and separated by the piston top end 33 when the first piston 31 is in its top dead center.

The exhaust port 38 is configured to exhaust combusted gas from the cylinder 30. The exhaust port 38 is arranged distal from the top end 33 of the first cylinder 30. Hereby, the intake port 35 and the exhaust port 38 are located at different positions and separated by the top end 33 when the first piston 31 is in its TDC. In this context, the term “distal” means that the exhaust port 38 is arranged spaced apart from the top end 33 in a direction Z (see FIG. 2c) of the cylinder 30 corresponding to an axial direction A of the piston 31. The top end 33 is thus considered to be a proximal part of the cylinder 30. In other words, the piston 31 is arranged in the cylinder 30 for reciprocal movement along the central axis ZA1, here extending in the direction Z. In other words, in this example, the axial direction A of the piston 31 corresponds to the direction Z (see FIG. 2c). The central axis ZA1 is thus arranged in parallel to the direction Z. Hence, the exhaust port 38 is arranged axially distal from the top end 33 of the cylinder 30 in the axial direction A of the cylinder 30 and the piston 31, here corresponding to the direction Z.

By way of example, the exhaust port 38 is arranged at a lower to mid part of the cylinder 30.

Turning again to FIGS. 2a and 2b, the axial upper part 74 of the piston 31 comprises a number of compression rings 71, 72 for sealing at the combustion chamber.

As further illustrated in FIGS. 2a and 2b, the axial lower part 75 comprises at least one compression ring 78 configured to seal along a region 73 of the cylinder wall 30a axially below the exhaust port 38, so as to reduce leakage of blow by gases from the combustion chamber 32 into a crankcase volume part 69 of the ICE 20. In this context, blow by gases generally refer to combustible fuel and exhaust residuals. That is, the blow by gases contains combustible fuel and exhaust residuals.

Hereby, it becomes possible to reduce the risk of having soot and oil particles mixed into the combustion process. This arrangement of the ICE system may further contribute to reduce time-to-ignition, while also decreasing the risk of having backfiring into the induction system of the ICE system.

During the combustion process, the force of high-pressure gases presses the compression rings 71, 72, 78 against the cylinder wall 30a which provides an effective sealing. This pressure pushing each one of the rings is generally proportional to the combustion gas pressure.

The topmost compression ring 71 provides for sealing any kind of leakage inside the combustion chamber 32 during the combustion process. The other compression ring 72 provides further sealing in a similar vein. Hence, the compression rings 71, 72 provide sealing above the piston 31 and prevent gas leakage from the combustion side.

In regard to the crankcase volume part 69, several options are possible within the arrangement of the ICE system 10.

In general, as illustrated in FIG. 2a, the crankcase volume part 69 is arranged axially below the exhaust port 38 and generally axially below the piston 31 at its BDC.

By way of example, the ICE system 10 comprises a common crankcase housing 65 for a pair of cylinders, including the cylinder 30. In this examples, the common crankcase housing 65 comprises the crankcase volume part 69. Alternatively, the ICE system 10 comprises multiple set of pair of cylinders where the ICE system 10 comprises a common crankcase housing for all cylinders of the ICE 20. In this examples, the common crankcase housing comprises the crankcase volume part 69.

Turning again to FIG. 2a, the at least one compression ring 78 of the axial lower part 75 and a compression ring of the number of compression rings of the axial upper part 74 are arranged on the piston 31 to provide an intermediate ring land 79 where blow by gases can be trapped and evacuated through the exhaust port. Accordingly, the piston 31 also comprises an intermediate ring land 79. The intermediate ring land 79 extends in the axial direction A and in the circumferential direction C of the piston 31. The intermediate ring land 79 is denoted as an “intermediate ring land” as it extends axially in-between the compression rings 72 and 78. The intermediate ring land is a surface region on the piston skirt 70.

More specifically, as illustrated in FIG. 2a, the intermediate ring land 79 extends in the axial direction A between the lowermost compression ring 72 of the number of compression rings of the axial upper part 74 and the compression ring 78 of the axial lower part 75.

In some examples, the axial lower part of the piston 31 comprises the at least one compression ring 78, an additional compression ring (not illustrated), the additional compression ring being arranged axially below the at least one compression ring 78, and further the oil control ring 76, the oil control ring being arranged axially below the Napier-type compression ring.

In some examples, the axial lower part of the piston 31 comprises the at least one compression ring 78, an additional compression ring in the form of a Napier-type compression ring, the Napier-type compression ring being arranged axially below the at least one compression ring 78, and further the oil control ring 76, the oil control ring being arranged axially below the Napier-type compression ring.

As such, in this example, the piston skirt 70 is defined by the axial upper part 74, the axial lower part 75 and the intermediate ring land 79 extending between the axial upper part 74 and the axial lower part 75. Other configurations may also be possible, such that the intermediate ring land 79 is an integral part of any one of the parts 74 and 75.

More specifically, the piston 31 is provided with the piston skirt 70 where its upper region comprises an upper ring pack with one or more compression rings 71, 72, while the lower region having the corresponding lower ring pack with the compression ring 78.

As illustrated in FIG. 2a, the at least one compression ring 78 of the axial lower part 75 is arranged on the piston 31 such that a position of the at least one compression ring 78 is axially below the exhaust port 38 at the TDC of the piston 31. More specially, as illustrated in FIG. 2a, the compression ring 78 of the axial lower part 75 is arranged on the piston 31 such that the compression ring 78 is axially below a lower end 38b of the exhaust port 38 at the TDC of the piston 31. As such, the compression ring 78 is never above the exhaust port 38, as seen in the axial direction A, during the combustion cycle.

Put it differently, the at least one compression ring 78 of the axial lower part 75 is arranged on the piston 31 such that the at least one compression ring 78 is never positioned above the lower end 38b of the exhaust port 38 at the TDC of the piston 31.

Moreover, in this example, as depicted in FIGS. 2a and 2b, the number of compression rings 71, 72 of the axial upper part 74 is arranged on the piston 31 such that the compression rings 71, 72 are positioned axially below the exhaust port 38 at the BDC of the piston 31.

Accordingly, the compression ring 78 of the axial lower part 75 is never positioned above the lower end 38b of the exhaust port 38 during a reciprocating movement of the piston 31 in the cylinder 30, as illustrated in FIG. 2a, while the compression rings 71, 72 of the axial upper part 74 always passes the entire opening of the exhaust port 38 during the reciprocating movement of the piston 31, as illustrated in FIG. 2b. This generally means that the compression rings 71, 72 passes below the lower end 38b of the exhaust port 38 when the piston 31 travels from TDC to BDC. This is also illustrated in FIG. 2b.

Further, the piston 31 and the cylinder 30 are here also provided such that an axial length of the piston 31 in relation to an axial length of the cylinder wall 30a ensures that the compression ring 78 of the axial lower part 75 is never positioned above the lower end 38b of the exhaust port 38 during a reciprocating movement of the piston 31 in the cylinder 30, while the compression rings 71, 72 of the axial upper part 74 always passes the entire opening of the exhaust port 38 during the reciprocating movement of the piston 31.

For the sake of completeness, the exhaust port 38 also has an upper end 38a, as illustrated in FIGS. 2a and 2b. The opening of the exhaust port 38 is thus generally defined by the axial distance between the upper end 38a and the lower end 38b. As illustrated in e.g. FIGS. 2a and 2b, the intermediate ring land 79 is generally larger than the axial distance between the upper end 38a and the lower end 38b.

Accordingly, the opening of the exhaust port 38 is open and closed by the piston 31 (when reciprocating between BDC and TDC).

The number of compression rings 71, 72 of the axial upper part 74 here comprises at least two compression rings. The number of compression rings of the axial upper part 74 may in other examples be more than two, e.g. three compressions rings.

Each one of the compression rings 71, 72 and 78 extend in the circumferential direction C.

In FIGS. 2a and 2b, the compression ring 78 of the axial lower part 75 is arranged in a groove 77 extending circumferentially around the piston skirt.

It should be noted that all compression rings may generally be positioned in corresponding grooves, as illustrated in FIGS. 2a and 2b. Accordingly, the compression rings 71, 72 are arranged in corresponding circumferentially extending grooves.

In this example, the axial lower part 75 of the piston 31 also comprises an oil control ring 76 arranged axially below the compression ring 78. The oil control ring 76 is configured to distribute oil during movement of the piston 31 along the cylinder wall 30a. The oil control ring 76 is generally located at the bottom of the piston 31 and closest to the crankcase volume part. The function of the oil control ring is also to scrape any excess oil from the walls of the cylinder liner when the piston 31 is in motion.

The oil control ring 76 is, however, an optional ring for the piston 31, and other arrangements of rings may also be possible. The oil control ring 76 is also arranged and positioned in a corresponding groove as the other rings. Oil control rings can be one-piece or multiple pieces. To increase the contact pressure between the ring and the liner surface, the rings can have chamfered edges on either the outer sides of the lands or facing the combustion chamber to reduce the oil consumption through improved oil scraping from the bore.

It should be noted that any one of the compression rings 71, 72, 78 can be defined by a homogenous rectangular cross-section or a tapered cross-section. In FIGS. 2a and 2b, each one of the compression rings 71, 72, 78 has a homogenous rectangular cross-section. In this context, the cross-section is defined by an extension in the axial direction A and an extension in the radial direction R.

The compression rings 71, 72, 78 and the oil control rings can be made of cast iron, and typically be further coated by an alloy, as is commonly known. The most common form of alloying cast iron is chromium, molybdenum, vanadium, titanium, nickel, and copper. The piston ring material should generally be kept harder than the cylinder liner to provide increased life.

FIG. 3 illustrates another type of compression ring for the piston 31 in FIGS. 2a and 2b. In FIG. 3, the compression ring is a Napier-type compression ring. In one example, the at least one compression ring 78 of the axial lower part is a Napier-type compression ring.

At least two designs are possible for Napier-type compression rings. The first one has a rectangular cross-section with a recessed geometry at a bottom outer surface. The second one is similar but incorporates a slight taper on the outside face. The result is a sort of hook or claw in cross-section as the inner face is undercut. In FIG. 3, there is illustrated a Napier-type compression ring 78 having such recessed geometry 178.

Turning now to FIG. 2c illustrating further details of the ICE system 10 as illustrated in FIGS. 2a to 2b.

In FIG. 2c, the at least one cylinder in FIGS. 2a to 2b is denoted as the first cylinder 30. In a similar vein, the other features described in relation to FIGS. 2a and 2b are in FIG. 2c denoted with the term first. In other words, the piston in FIGS. 2a and 2b is here a reciprocating first piston 31, or simply the first piston 31, the cylinder wall is here a first cylinder wall 30a, the cylinder head is here a first cylinder head 30b etc. The above examples of the arrangement of the cylinder 30, the piston 31, the cylinder wall 30a, the cylinder head 30b and any one of the rings, such as the compression ring 78 are applicable to the first cylinder and its components as well as to any other herein-described cylinder, such as the second cylinder, a third cylinder etc.

In FIGS. 2c, the ICE system 10 is a spark-ignition ICE system. The ICE system 10 comprises the two-stroke ICE 20 operable on a gaseous fuel 50 or a liquid fuel 50.

In this example, the two-stroke ICE 20 is operable on a gaseous fuel in the form of a hydrogen-based fuel. The combustion in such hydrogen ICE system 10 is based on a combustion of air and hydrogen, as is commonly known in the art. While the combustion of hydrogen with oxygen may only produce water as its only product in a pure combustion process between hydrogen and oxygen, a hydrogen ICE system 10 based on combustion of air and hydrogen generally produce water, heat and NOx, as is commonly known in the art. In addition, hydrogen can be combusted in an internal combustion engine over a wide range of fuel-air mixtures. A hydrogen ICE system 10 may be operated to produce very low emissions during certain conditions. The hydrogen ICE system 10 may operate based on hydrogen liquid or hydrogen gas. The hydrogen ICE system 10 as described herein contributes to a more lean operation of the ICE 20, which is favorable from a NOx emission perspective.

As depicted in FIG. 2c, and further in FIGS. 4A to 4D, the ICE 20 comprises the first cylinder 30 and a second cylinder 40. The first cylinder 30 comprises the first cylinder wall 30a and the first cylinder head 30b. The first cylinder wall may be part of a cylinder liner. In a similar vein, the second cylinder 40 comprises a second cylinder wall 40a and a second cylinder head 40b. The second cylinder wall may be part of a corresponding cylinder liner.

The first and second cylinders 30, 40 are here a pair of first and second cylinders 30, 40. Typically, although strictly not required, the first and second cylinders 30, 40 are here a pair of neighboring first and second cylinders 30, 40. In this context, the term “neighboring” generally means that the cylinders are arranged next to each other, i.e. adjacent to each other within the ICE system, so as to allow for forming a pair of cylinders operating according to the two-stroke operation. In other words, the first and second cylinders 30, 40 are arranged next to each other in the ICE 20. This may have a positive impact on the volumetric efficiency of the ICE system 10. However, it should be noted that the first and second cylinders may in some ICE systems be arranged slightly distanced from each other as long as the cylinders work as a pair of cylinders, i.e. the cylinders are connected to the same crank shaft and separated with a 180 crank angle degrees, as further described herein.

It should be noted that the ICE 20 may comprise any number of cylinder. In particular, the ICE 20 may comprise any even number of cylinders. For example, the ICE 20 may comprise four, six, or eight cylinders. For ease of reference, however, the description herein is for an ICE system 10 having a pair of cylinders 30, 40.

As illustrated in FIG. 2c, the ICE system 10 further comprises a crank shaft 27, a set of connecting rods, 28, 29 and the crankcase 65. The crankcase 65 is configured to accommodate the crank shaft 27 and the connecting rods 28, 29. Each one of the connecting rods 28, 29 is operatively connected to a corresponding piston, as further described below.

In this example, as illustrated in FIG. 3c, the ICE system 10 comprises a common crankcase housing 65 for the two cylinders 30, 40. Hence, in this examples, the common crankcase housing 65 comprises a common crankcase volume part 69 for a pair of cylinders 30, 40.

The ICE system 10 may also comprise an oil sump 62 and a splash plate for the oil 68. These components are conventional parts of an ICE, and not further described herein.

The first cylinder 30 is configured to accommodate the reciprocating first piston 31. The reciprocating first piston 31 is operable between a bottom dead center, BDC, and a top dead center, TDC.

More specifically, as may be gleaned from FIG. 4A in combination with FIG. 4D, the first piston 31 is arranged to reciprocate in the first cylinder 30 between the BDC (FIG. 4D) and the TDC (FIG. 4A)). With reference to FIG. 4D, the first piston 31 is in the TDC position at −360°, 0° and 360° CAD. The first piston 31 is via a connection rod 28 connected to the crank shaft 27, which is in line with a conventional internal combustion engine.

The first piston 31 here comprises the piston rings as described and illustrated in relation to FIGS. 2a and 2b. By way of example, the first piston 31 comprises the compression rings 71, 72, the compression ring 78 and the oil control ring 76. The number of piston rings and type of piston rings are selected based on the fuel of the ICE system 10. In this example, the piston rings are arranged at the axial upper part 74 of the top end 33 of the first piston 31 and at the axial lower part 75 of the first piston 31, as illustrated in FIGS. 2a and 2b.

The reciprocating first piston 31 further at least partly defines a first combustion chamber 32 with the top end 33 of the first piston 31. The first combustion chamber 32 is arranged at the end portion, i.e. the first cylinder head 30b, of the first cylinder 30 so that an upper surface of the top end 33 defines a lower side of the first combustion chamber 32.

The first cylinder 30 further comprises an ignition source 34. The ignition source 34 is arranged in the first combustion chamber 32. The ignition source 34 is arranged in the first cylinder 30 and at a location facing the combustion chamber 32. By way of example, the ignition source 34 is arranged at an upper end of the cylinder 30, as illustrated in FIG. 2. In particular, the ignition source 34 is arranged at the cylinder head 30b of the first cylinder 30. Other arrangements of the ignition source are also conceivable.

The ignition source 34 is configured to ignite the hydrogen gas supplied via the fuel arrangement, as described herein. By way of example, the ignition source is a spark-plug 17. A spark plug is a device for delivering electric current from an ignition system to the combustion chamber of a spark-ignition engine to ignite the compressed fuel/air mixture by an electric spark, while containing combustion pressure within the engine.

In addition, the first cylinder 30 of the ICE 20 comprises at least one intake port 35 arranged at a top end 36 of the first cylinder 30 and in fluid communication with the combustion chamber 32. The top end 36 is here an integral part of the cylinder head 30b.

Moreover, the flow of combustible gas through the at least one intake port 35 is controllable by an intake control valve 37. In this example, the combustible gas may generally contain a mix of air and port injected hydrogen gas (the gaseous fuel).

The intake control valve 37 is arranged to open and close a fluid passage of the intake port 35, thus controlling the flow of fluid to the combustion chamber 32.

Further, the first cylinder 30 of the ICE 20 comprises an exhaust port 38 arranged distal from the top end 36 of the first cylinder 30, such that the at least one intake port 35 and the exhaust port 38 are located at different positions and separated by the piston top end 33 when the first piston 31 is in its top dead center.

More specifically, as illustrated in FIG. 2c, the first cylinder 30 comprises a first exhaust port 38. The first exhaust port 38 is configured to exhaust combusted gas from the first cylinder 30. The first exhaust port 38 is arranged distal from the top end 33 of the first cylinder 30. Hereby, the intake port 35 and the exhaust port 38 are located at different positions and separated by the top end 33 when the first piston 31 is in its TDC. In this context, the term “distal” means that the exhaust port 38 is arranged spaced apart from the top end 33 in a direction Z of the cylinder 30 corresponding to an axial direction of the piston 31. The top end 33 is thus considered to be a proximal part of the first cylinder 30. In other words, the first piston 31 is arranged in the first cylinder 30 for reciprocal movement along a central axis ZA1, here extending in the direction Z. In other words, in this example, the axial direction of the piston 31 corresponds to the direction Z. the central axis ZA1 is thus arranged in parallel to the direction Z. Hence, the first exhaust port 38 is arranged axially distal from the top end 33 of the first cylinder 30 in the axial direction of the first cylinder 30 and the first piston 31, here corresponding to the direction Z.

By way of example, the exhaust port 38 is arranged at a lower to mid part 39 of the first cylinder 30.

In some examples, as illustrated in FIG. 2c, when the first cylinder 30 comprises the first cylinder liner, the cylinder liner here also comprises the exhaust port 38 located at a lower to mid part 39 of the cylinder liner. Hence, the exhaust port 38 is generally arranged distal from the top end 33 of the first cylinder 30 and positioned in the cylinder wall 30a of the cylinder liner of the first cylinder 30.

The second cylinder 40 is configured to accommodate a reciprocating second piston 41. The reciprocating second piston 41 is operable between a bottom dead center, BDC, and a top dead center, TDC.

More specifically, as may be gleaned from FIG. 4A in combination with FIG. 4D, the second piston 41 is arranged to reciprocate in the second cylinder 40 between the BDC (FIG. 4A) and the TDC (FIG. 4D). With reference to FIG. 4A, the second piston 41 is in the TDC position at −360°, 0° and 360° CAD. The second piston 41 is via a connection rod 29 connected to the crank shaft 27, which is in line with a conventional internal combustion engine.

The second piston 41 here comprises a set of piston rings as described and illustrated in relation to FIGS. 2a and 2b. By way of example, the second piston 41 comprises corresponding compression rings 71, 72, a corresponding compression ring 78 and a corresponding oil control ring 76. The number of piston rings and type of piston rings are selected based on the fuel of the ICE system 10. In this example, the piston rings are arranged at the axial upper part 74 of the top end 33 of the second piston 41 and at the axial lower part 75 of the second piston 41, as illustrated in FIGS. 2a and 2b.

The reciprocating second piston 41 further at least partly defines a second combustion chamber 42 with a top end 43 of the second piston 41. The combustion chamber 42 is arranged at end portion, i.e. the second cylinder head 40b, of the second cylinder 40 so that an upper surface of the top end 43 defines a lower side of the second combustion chamber 42.

Each one of the piston top ends may have a flat top or the piston top ends may be slightly dished so as to avoid hotspots.

The second cylinder 40 further comprises a corresponding ignition source 44 arranged in the second combustion chamber 42. The ignition source 44 is arranged in the second cylinder 40 and at a location facing the combustion chamber 42. By way of example, the ignition source 44 is arranged at an upper end of the combustion cylinder 40, as illustrated in FIG. 2. In particular, the ignition source 44 is arranged at the cylinder head 40b of the second cylinder 40. Other arrangements of the ignition source are also conceivable.

Each one of the ignition sources 34, 44 is here a spark plug. The ignition source may also be a glow plug.

Accordingly, in each cylinder, there is a corresponding spark plug arranged to ignite a mix of fuel and oxygen in the cylinder. The hydrogen fuel is generally compressed to a certain level. The compressed air-fuel mixture is thus ignited by the spark plug.

In addition, the second cylinder 40 of the ICE 20 comprises at least one corresponding intake port 45 arranged at a top end 46 of the second cylinder 40 and in fluid communication with the second combustion chamber 42. The top end 46 is here an integral part of the cylinder head 40b.

Moreover, the flow of combustible gas through the at least one corresponding intake port 45 is controllable by a corresponding intake control valve 47. In this example, the combustible gas may generally contain a mix of air and port injected hydrogen gas (the gaseous fuel).

The intake control valve 47 is arranged to open and close a fluid passage of the intake port 45, thus controlling the flow of fluid to the combustion chamber 42.

Further, the second cylinder 40 of the ICE 20 comprises a corresponding exhaust port 48 arranged distal from the top end 46 of the second cylinder 40, such that the at least one corresponding intake port 45 and the corresponding exhaust port 48 are located at different positions and separated by the piston top end 43 when the corresponding second piston 41 is in its top dead center.

In a similar vein to the first cylinder and its exhaust port, the corresponding exhaust port 48 is configured to exhaust combusted gas from the second cylinder 40. The corresponding exhaust port 48 is arranged distal from the top end 43 of the second cylinder 40. Hereby, the intake port 45 and the exhaust port 48 are located at different positions and separated by the top end 43 when the second piston 41 is in its TDC. In this context, the term “distal” means that the exhaust port 48 is arranged spaced apart from the top end 43 in the direction Z of the second cylinder 40 corresponding to an axial direction of the second piston 41. The top end 43 is thus considered to be a proximal part of the second cylinder 40.

More specifically, the second piston 41 is arranged in the second cylinder 40 for reciprocal movement along a central axis ZA2, here extending in the direction Z. In other words, in this example, the axial direction of the second piston 41 corresponds to the direction Z. The central axis ZA2 is thus arranged in parallel to the direction Z. Hence, the second exhaust port 48 is arranged axially distal from the top end 43 of the second cylinder 40 in the axial direction of the second cylinder 40 and the second piston 41, here corresponding to the direction Z.

By way of example, the exhaust port 48 is arranged at a lower to mid part 49 of the second cylinder 40. The exhaust port 48 is arranged at a lower to mid part 49 of the second cylinder 40 as seen along the central axis ZA2.

It should be noted that in FIG. 2c, the first central axis ZA1 of the first piston 31 is arranged parallel to the second central axis ZA2 of the second piston 41. However, the pistons may also be arranged in a slightly different configuration where the first central axis ZA1 of the first piston 31 is arranged non-parallel to the second central axis ZA2 of the second piston 41, at least as long as the first and second cylinders are arranged separated from each other with a crank angle of 180 degrees.

In some examples, as illustrated in FIG. 2c, when the second cylinder 40 comprises the second cylinder liner, the cylinder liner comprises the corresponding exhaust port 48 located at a lower to mid part 49 of the cylinder liner. Hence, the corresponding exhaust port 48 is generally arranged distal from the top end 43 of the second cylinder 40 and positioned in the cylinder wall 40a of the cylinder liner of the second cylinder 40.

As illustrated in FIG. 2c, the pair of neighboring first and second cylinders 30, 40 are arranged separated from each other with a crank angle of 180 degrees (180 CAD). In this manner, the cylinders 20, 30 are separated from each other so to provide a 180 degrees combustion phasing separation. As such, the cylinders 30, 40 can be arranged in the ICE system 10 to provide a 180 degrees cycle separation irrespectively of the ICE and cylinder arrangement/configuration.

By arranging the exhaust ports 38, 48 in the lower to mid parts of the cylinders 30, 40, the respective intake ports 35, 45 and exhaust ports 38. 48 are in each cylinder 30, 40 located at different positions and separated by the respective piston top end 33, 43 when the respective piston is in its TDC. Accordingly, by the provision of arranging the respective intake port 35, 45 and exhaust port 38, 48 of the cylinders 30, 40 at different positions along the direction Z (i.e. along the axial directions of the pistons and cylinders), the corresponding piston will provide for a blocking effect between the intake and exhaust ports when the corresponding piston is in its TDC, so that the hot part of the cylinder (exhaust port and cylinder wall/liner) will be entirely separated from the combustible gas (air). The blocking effect is at least schematically illustrated in FIG. 2c, and also in FIGS. 4A and 4D.

As such, the configuration of the intake and exhaust ports enables a length-scavenging ICE system that separates the hot exhaust end of each cylinder from the cold intake end where the combustibles are present. Therefore the knock risk may be reduced during operation of the ICE system 10. In comparison with a two-stroke diesel ICE using multiple cylinders, this also allows for a reversed scavenging of the corresponding combustion chamber with the controllable intake valves in the cylinder head and the exhaust ports at the cylinder wall/liner (e.g. in the lower part of cylinder wall). In other words, there are no exhaust valves in the cylinder head as compared to more conventional ICE systems.

By the combination of the arrangement of the ignition source 34, 44 and the position of the intake and exhaust ports 35, 45, 38, 48, the ICE system 10 is configured to provide a forced induction in the top of the cylinders, an ignition source for igniting the fuel in each combustion chamber 32, 42, while further being configured to expel the exhaust gases through respective exhaust port 28, 38 in the lower to mid parts of the respective cylinder, e.g. lower parts of the walls 30a, 40a of the cylinder liners.

Further, as depicted in FIG. 2c, the ICE system 10 comprises an air intake duct 22. The air intake duct 22 is a manifold which is arranged and configured to feed intake air to the cylinders, in this example the first and second cylinders 30, 40.

The air intake duct 22 comprises a positive displacement device 23, as illustrated in FIG. 2c. The positive displacement device 23 is configured to receive and feed intake air 51 to the at least one pair of neighboring cylinders 30, 40. The air intake duct 22 comprises an intake tract 24 and a plenum 25. The air intake tract 24 is arranged upstream the positive displacement device 23. The plenum 25 is arranged downstream the positive displacement device 23. The positive displacement device 23 is also arranged in the air intake duct 22 to separate the upstream intake tract 24 from the downstream plenum 25 of the air intake duct 22.

It should be noted that the plenum 25 may in some examples be an integral part of the cylinder heads of the cylinders. Hence, at least parts of the air intake duct may be integral parts of the cylinder heads of the cylinders.

The positive displacement device 23 is configured to fluidly seal against back flow from the combustion chamber(s) 32, 42. Furthermore, the positive displacement device 23 is configured to exhaust its (complete) internal displacement for each revolution.

The positive displacement device 23 is here a positive displacement pump. The positive displacement pump is configured to displace gas from an upstream position to a downstream position of the air intake duct 22 thereof by trapping a fixed amount of air and forcing that trapped amount of air from the upstream position to the downstream position.

By way of example, the positive displacement device 23 is a rotary roots type blower having a pair of rotary members 23a, 23b provided with meshing lobes. Other configurations of the positive displacement device may also be readily appreciated.

The positive displacement device 23 is here a variable positive displacement device configured to be operated in a variable manner. The use of a variable driven positive displacement device allows for a higher flexibility of the air intake duct forming the air intake system of the ICE system 10. The use of a variable driven positive displacement device also contributes to improve the overall function of the ICE system 10. Positive displacement devices may generally operate with flow and pressure as independent variables. This means that if pressure increases and speed remains constant, the flow rate is largely unaffected. A variable positive displacement device, such as a pump, is a device that converts mechanical energy to hydraulic (fluid) energy. The displacement can be varied while the pump is running. The positive displacement device may be driven variably for the high flexibility and improved functionality of the ICE system.

The positive displacement device 23 may be electrically driven, hydraulically driven, etc. An electrified positive displacement device may also improve turbo transients by boosting with scavenging that may also drive the turbine in the turbo. Such configuration of the ICE system may allow for reduced pressure before the displacement pump and/or after the turbo compressor reducing compressor work instantly.

The upstream intake tract 24 is here an integral part of the air intake duct 22. The intake duct 24 is by way of example provided in the form of a cylindrical shaped housing having an inner volume. The plenum 25 is also generally an integral part of the air intake duct 22.

Also, as illustrated in FIG. 2c, the downstream plenum 25 is in fluid communication with each one of the first and second cylinders 30, 40. By way of example, as illustrated in FIG. 2c, the downstream plenum 25 is in fluid communication with each one of the first and second cylinders 30, 40 via respective intake ports 35, 45.

In FIG. 2c, the downstream plenum 25 is provided in the form of a so-called Siamese-shaped design. Such Siamese-shaped design has a first inlet conduit 25a and a set of two outlet conduits 25b, 25c, as schematically illustrated in FIG. 2c. The diameter and length of the inlet and outlet conduits may vary depending on the type of ICE system 10, and the plenum 25 in FIG. 2c is only schematically illustrated.

The plenum 25 comprises an air inlet 25d in fluid communication with the positive displacement device 23 and a plurality of outlets 25e, 25f configured to be in fluid communication with the intake ports 35, 45 of the first and second cylinders 30, 40, respectively. The first inlet conduit 25a has the air inlet and the outlet conduits 25b, 25c have the corresponding outlets.

Accordingly, the plenum 25 is defined by the conduit arrangement between the intake ports 35, 45 of the first and second cylinders 30, 40 and the positive displacement device 23, as depicted in e.g. FIG. 2c.

The plenum 25 may also be provided in other ways, e.g. by a single large inner volume defined by a common conduit. The internal volume of the plenum should generally be selected to provide an efficient backfire protection, and may thus benefit from being minimized in volume in view of the other volumes of the other components.

The plenum 25 in combination with the arrangement and configuration of the positive displacement device 23 provides for an improved air supply system for supplying air to the cylinders 30, 40.

It should be noted that even though the positive displacement device 23 provides for an essentially fluid-tight seal in the air intake duct 22, it will be a continuous flow of air through the positive displacement device 23 thanks to the configuration of the cylinders 30, 40 with a 180 CAD separation, since the pair of cylinders 30, 40 interact with respect to the intake event.

By the arrangement of the positive displacement device 23 in the air intake duct 22, the positive displacement device 25 is arranged to eliminate, or at least reduce, the risk of having pressure pulses transferred backwards from the combustion chambers 30, 40 to the upstream intake tract 24 of the air intake duct 22.

As such, the intake ports 35, 45 are mechanically isolated from the intake tract 24. The positive displacement device 23 is thus arranged to seal the cylinders 30, 40 and the downstream plenum 25 from the upstream intake tract 24 of the air intake duct 22 (intake manifold) in case of backfire. Such arrangement of the ICE system thus allows for better controlling the risk of backfiring, i.e. a condition when a flame escapes from the combustion chamber of the cylinder and travels upstream into the air intake duct.

Also, by the arrangement and configuration of the positive displacement device 23 in the air intake duct 22, the positive displacement device 23 can still provide an even flow by alternating feed to the cylinder pair 30, 40.

Moreover, in some examples, as described in relation to FIG. 3, the general ICE system 10 provides for suppressing the tendency for knock and/or self-ignition of the fuel, such as a gaseous fuel, e.g. hydrogen-based fuel. This is e.g. provided by the combination of having a separate intake plenum 23 for each pair of cylinders 30, 40 with the 180 degrees combustion phasing separation, and where the intake duct 22 has a close coupled positive displacement device 23 for each pair of cylinders 30, 40. By arranging the positive displacement device 25 close to the cylinders, the internal volume of the plenum 25 can be minimized, thus providing for an even more efficient backfire protection.

The ICE system 10 here comprises a fuel injector arrangement 26, as illustrated in FIG. 2c. The fuel injector arrangement 26 is arranged in the plenum 25 of the air intake duct 22 so as to provide a fuel injection upstream the intake ports 35, 45 of the cylinders 30, 40. In this manner, there is provided an improved injection of fuel into the combustion chambers 32, 42 of the ICE 20.

The fuel injector arrangement 26 comprises at least one fuel injector configured inject fuel. In FIG. 2c, the fuel injector arrangement 26 comprises a set of two fuel injector, 26a, 26b. There is generally one fuel injector 26a, 26b arranged upstream respective intake port 35, 45. By way of example, the outlet conduit 25b comprises a first fuel injector 26a and the outlet conduit 25c comprises the second fuel injector 26b. Hereby, the ICE system 10 is configured to provide port injection of the gaseous fuel 50 upstream respective intake port 35, 45. The use of a port injection allows for providing a homogenous mixture which enables an improved knock and auto-ignition control and contribute to reduce the emissions.

The fuel injector arrangement 26 is controllable/operable in response to a fuel injection event such that fuel injection is injected to one or more of the corresponding intake ports 35, 45 such that pressure pulses are generated in the plenum 25 and subsequently travel into the corresponding combustion chambers 32, 42. Hereby, there is provided an improved scavenging effect. As such, the ICE system 10 is configured to provide a scavenging effect by the injection timing in the respective intake port 35, 45.

By way of example, the fuel injector arrangement 26 is controllable/operable to provide a sequential injection of fuel to the cylinders 30, 40 so as to allow for an active cylinder scavenging during a latter part of a corresponding intake stroke of a corresponding cylinder of the cylinders 30, 40. The fuel injector arrangement is here controlled by the control unit.

Put it differently, a sequential injection enables active cylinder scavenging (emptying of exhaust) during latter part of the intake stroke and creates a final pressure pulse (from the injected fuel) that increases the trapped mass in the cylinder after any exhaust port and intake valve closures. This may also contribute to a fuel-free plenum and/or intake port after the intake valve closure.

Further, the generated pressure pulse increases the scavenging effect.

It may be noted that the sequential injection can be tuned for different speeds and valve timings.

In general, the pressure pulse will also travel backwards in the downstream plenum 25. For instance, the pressure pulse will be reflected in the sister cylinder intake valve that is closed. Thereafter, the pressure pulse travels back to the still open intake valve and enters the cylinder with the open valve and complete the cylinder filling, thus also contributing to the complete trapped mass.

In some examples, although not illustrated, the fuel injectors 26a, 26b of the fuel injector arrangement 26 may be arranged in each one of the combustion chambers of the cylinders.

Turning again to the intake ports 35, 45 and intake valves 37, 47, the ICE system 10 in FIG. 2 is here provided with a number of two intake valves 37 for the first cylinder 30 and a number of two intake control valve 47 for the second cylinder 40.

Hence, in some examples, each one of the cylinder heads 30b, 40b comprises a number of at least two intake control valves. In some examples, each one of the cylinder heads 30b, 40b of the first and second cylinders 30, 40 may have a plurality of intake control valves. By way of example, each one of the cylinder heads may have a number of four intake control valves. Such configuration provides for an even more improved air supply system for supplying air to each one of the cylinders. A configuration with an ICE system having four intake control valves for each cylinder is particularly beneficial for two-stroke operated ICE systems operable on a hydrogen-based fuel because it has a shorter intake period than a four stroke ICE system. Also, a configuration with an ICE system having four intake control valves for each cylinder allows for increasing the air intake rate into the combustion chambers 32, 42 of the cylinders 30, 40, thus also improving the volumetric efficiency. To this end, an ICE system 10 comprising the arrangement of the positive displacement device 23 in combination with the arrangement of four intake valves in each cylinder enables an even more improved volumetric efficiency, at least in comparison with conventional ICE system, such as a four-stroke ICE system.

In FIG. 2c, the intake control valves 37, 47 are configured to provide variable valve actuation. The variable valve actuation can be provided by a hydraulic system, electronic system or pneumatic system. However, the intake control valves 37, 47 may also be conventional intake control valves, such as a camshaft-based system, as is commonly used in diesel ICE systems. Hence, in some examples, the intake control valves are conventional camshaft actuated valves. Such camshaft actuated valves may also include variable valve actuation depending on arrangement and configuration of the valves.

In FIG. 2c, the ICE system 10 comprises an inlet control valve actuation assembly 63 for actuating the at least one inlet control valve 37 and the corresponding inlet control valve 47. The inlet valve actuation assembly 63 is adapted to actuate the inlet control valves 37, 47 in accordance with one or more lift modes during the combustion cycle of the ICE system, which will also be further described in relation to FIGS. 4A to 4D.

As may also be gleaned from FIG. 2c, each one of the exhaust ports 38, 48 is arranged in fluid communication with an exhaust duct 61 arranged to transport exhaust gas away from each one of the cylinders.

Moreover, as illustrated in FIG. 2c, the ICE system 10 here comprises a turbocharger arrangement 170. The turbocharger arrangement 170 comprises a turbocharger turbine 171 operatively connected to a turbocharger compressor 172, wherein the turbocharger compressor 172 is arranged in an air intake conduit 173 in fluid communication with the air intake duct 22. The turbocharger turbine 171 is arranged in the exhaust duct 61 so as to drive the turbocharger compressor 172. In other words, the turbine 171 is configured to convert engine exhaust gas into mechanical energy to drive the compressor 172.

The turbocharger turbine 171 may be a conventional turbine for an ICE system 10. Alternatively, the turbocharger turbine 171 may be a variable geometry turbine in fluid communication with the cylinders.

In FIG. 2c, the ICE system 10 further comprises an exhaust gas recirculation, EGR, system 80 comprising an EGR conduit 81 arranged to connect the exhaust duct 61 and the air intake duct 22 so as to permit recirculation of exhaust gas through the cylinders during operation of the ICE.

The EGR system 80 here further comprises a corresponding positive displacement device 82. The positive displacement device 82 is disposed in the EGR conduit 81. The positive displacement device 82 is generally of the same type as the device 23, but may also be provided in other ways. The positive displacement device 82 is by way of example a roots blower.

The EGR conduit 81 connects to the air intake conduit 73 at a position 84 downstream the turbocharger compressor 172 and further connects to the exhaust duct 61 at a position 85 upstream the turbocharger turbine 171.

Typically, as illustrated in FIG. 2c, the ICE system 10 may also comprise an air cooler 67, such as charge air cooler (CAC). By way of example, the CAC 67 is arranged in the air intake conduit 173. More specifically, the CAC 67 is arranged in the air intake conduit 173 between the turbocharger compressor 172 and the air intake duct 172, as seen in a direction of flow from the compressor 172 to the air intake duct 22.

It should be readily appreciated that the air intake duct of FIG. 2c may have its own inlet for receiving fresh air from the outside and/or be configured to receive air from the air intake conduit 73.

For ICE systems 10 with a turbocharged arrangement 170 as illustrated in FIG. 2c, the positive displacement device 23 can work in several ways working in conjunction with the turbo mounted upstream:

If the intake air flow is at the desired level the positive displacement device 23 just spins to move the air volume past the rotors. In this instance, the positive displacement device consumes little energy since no compression is taking place. The part of blocking of the intake duct 22 from the upstream intake tract 24 is then also functioning (per design).

If in a transient state and the turbocharger have not spun up, the positive displacement device 23 can spin faster and support in getting the boost pressure up, thereby increasing the response of the ICE 20. Transient operation is generally challenging for H2 ICE system 10 with a traditional boosting setup since a transient normally result in reduced air/fuel ratio which in turn give a knock tendency or NOx creation. By controlling the air during the transient with additional boost, this issue may be eliminated, or at least reduced to a great extent.

At some operating points, where the turbo is not sufficient for the boosting the positive displacement device 23 can support with additional boosting for improved control of air/fuel ratio, cylinder scavenging etc., i.e. combustion control.

Moreover, in the ICE system 10 described in relation to FIG. 2a to 2c, the ICE system 10 further comprises the controller 90 configured to collectively control the positive displacement device 23 and the intake valves 37, 47 so as to control flow of gas to the respective combustion chambers 32, 42.

By way of example, the controller 90 is configured to terminate fuel injection during an intake phase and before an intake valve closure, whereby the remaining part of the intake phase comprises emptying the plenum 25 of fuel and subsequently introducing fresh air to the plenum 25 by operating the positive displacement device 23.

In the following, there is an example of a sequence of operating the ICE system 10 during the two-stroke operation. The sequence of the two-stroke operation is described in conjunction with FIGS. 4A to 4D.

In generally, it should be noted that each one of the first and second cylinders 30, 40 has three primary events. These events are compression event, combustion and work event, and exhaust and intake event. The compression event occurs when a corresponding piston is at an upper half of the corresponding cylinder when it travels from BDC to TDC. The combustion and work event occurs when a corresponding piston is at an upper half of the corresponding cylinder when it travels from TDC to BDC. The exhaust and intake event generally occurs when a corresponding piston is at a lower half of the corresponding cylinder. By way of examples, the exhaust and intake event occurs when a corresponding piston is at a lower half of the cylinder and is travelling towards its BDC, across its BDC and/or when the corresponding piston is at a lower half of the cylinder and is travelling towards its TDC.

It should, however, be noted that the exhaust and intake event may occur in different regions of the cylinders, and can be slightly divided, but the exhaust and intake event will generally occur at the same time. During the exhaust and intake event, the ICE system provides the scavenging effect, i.e. fresh intake gas pushes the residual exhaust out the exhaust port.

In view of the above, the piston 31, 41 of one of the cylinders 30, 40 may generally perform the compression phase (or event) during about 270-0 CAD, followed by the combustion and work phase (event) during 0-90 CAD at an upper half of the corresponding cylinder when the piston travels from TDC to BDC, while the other piston of the other cylinder performs the exhaust and intake phase (event) at a lower half of the other cylinder during 90 to 270 CAD. It may also be noted that there is generally an overlap between the end of the combustion and work phase (event) and the start of the exhaust and intake phase (event).

More specifically, as schematically illustrated in FIGS. 4A to 4D, the intake control valve 37 of the first cylinder 30 is controllable/operable in correlation with the movement of the first piston 31 and the intake control valve 47 of the second cylinder 40 is controllable/operable in correlation with the movement of the second piston 41. In this manner, the fluid communication between the respective combustion chambers 32, 42 and the plenum 25 is selectively open and closed during a crank shaft revolution of the ICE 20. As mentioned herein, such configuration of the ICE system 10 in combination with the positive displacement device 23 in the air intake duct 22 allows for reducing the risk of backfire.

The inlet control valve 37 and the corresponding inlet control valve 47 are controlled and actuated by the inlet control valve actuation assembly 63. Purely by way of example, the inlet control valve actuation assembly 63 may comprise an electric actuator (not shown) adapted to actuate the inlet control valve(s) in at least two lift modes, i.e. between an open mode and a closed mode. The control valves may alternatively, or in addition, be controlled by the control unit.

In addition, as mentioned above, the cylinders 30, 40 are separated from each other with a crank angle of 180 degrees. Such arrangement and configuration of the ICE system 10 allows for 180 degrees combustion phasing separation. The effect of the control of the intake ports by the intake valves in combination with the 180 degrees combustion phasing separation can be exemplified by the illustrations in FIGS. 4A and 4D:

In FIG. 4A, the first intake port 35 of the first cylinder 30 is closed by the inlet control valve 37 to close the fluid communication between the first combustion chamber 32 and the plenum 25 when the corresponding intake port 45 of the second cylinder 40 is open by the inlet control valve 47 to provide a fluid communication between the second combustion chamber 42 and the plenum 25. In FIG. 4A, the first piston 31 is positioned in its TDC. In this position, an ignition event of the first cylinder 30 is about to start, or has just been started. The inlet control valve 37 is thus closed. In addition, in FIG. 4A, the second piston 41 is at its BDC and the corresponding inlet control valve 47 of the second cylinder 40 is fully opened. The second cylinder 40 and the second piston 41 are here illustrated in a position corresponding to the exhaust and intake event, i.e. fresh intake gas from the intake port 45 enters the second cylinder 40 and pushes the residual exhaust out from the exhaust port 48. This simultaneous operation of the first and second pistons 31, 41 can be performed due to the 180 crank angel degrees separation between the cylinders 30, 40, here also providing the 180 degrees combustion phasing separation.

Subsequently, as illustrated in FIG. 4B, the first cylinder 30 and the first piston 31 perform the combustion and work phase, in which the first piston 31 travels from its TDC to its BDC. In this position, the inlet control valve 37 is closed. In addition, as illustrated in FIG. 4B, the second piston 41 in the second cylinder 40 travels from its BDC to its TDC, while performing its intake phase so as to receive fresh air from the corresponding intake port 45. In this position, the corresponding inlet control valve 47 is partly opened, as illustrated in FIG. 4B. This simultaneous operation of the first and second pistons 31, 41 can be performed due to the 180 crank angel degrees separation between the cylinders 30, 40, here also providing the 180 degrees combustion phasing separation.

In FIG. 4C, the first cylinder 30 and the first piston 31 are illustrated at the end of the combustion and work phase, in which the first piston 31 approaches its BDC. In this position, the inlet control valve 37 is controlled to move from its closed position to an opened position. Hence, in FIG. 4C, the inlet control valve 37 is illustrated in a partly opened position. In addition, as illustrated in FIG. 4C, the second piston 41 approaches its TDC while the corresponding inlet control valve 47 is set to its closed position. At this position, the second cylinder 40 and the second piston 41 perform the compression phase so as to compress the received fresh air. This simultaneous operation of the first and second pistons 31, 41 can be performed due to the 180 crank angel degrees separation between the cylinders 30, 40, here also providing the 180 degrees combustion phasing separation.

Finally, as illustrated in FIG. 4D, the first piston 31 is at its BDC and the corresponding inlet control valve 37 of the first cylinder 30 is fully opened. The first cylinder 30 and the first piston 31 are here in a position corresponding to the exhaust and intake event, i.e. fresh intake gas from the intake port 35 enters the first cylinder 30 and pushes the residual exhaust out from the exhaust port 38. In addition, the second piston 41 is positioned in its TDC. In this position, an ignition event of the second cylinder 40 is about to start, or has just been started. The corresponding inlet control valve 47 is thus closed. This simultaneous operation of the first and second pistons 31, 41 can be performed due to the 180 crank angel degrees separation between the cylinders 30, 40, here also providing the 180 degrees combustion phasing separation.

As may also be gleaned from FIG. 4D, the inlet control valve 37 at the first intake port 35 of the first cylinder 30 is open to provide a fluid communication between the first combustion chamber 32 and the plenum 25 when the corresponding intake port 45 of the second cylinder 40 is closed by the intake control valve 47 to close the fluid communication between the second combustion chamber 42 and the plenum 25.

In addition, as may be gleaned from FIGS. 4A to 4D, due to the arrangement of the first and second cylinders 30, 40 being arranged separated from each other with a crank angle of 180 degrees, the ICE system 10 is configured to operate the intake valves 37, 47 of the first and second cylinders 30, 40 such that the intake valves 37, 47 of the cylinders 30, 40 are completely closed when the respective piston is halfway up in the cylinder, which may further reduce the risk of a backfire.

Accordingly, by the configuration of having the first and second cylinders 30, 40 separated from each other by 180 crank angle degrees in combination with the arrangement of the positive displacement device 23, as illustrated in e.g. FIG. 2 in combination with FIGS. 4A to 4D, it becomes possible to reduce the risk of backfire.

Also, although not explicitly shown in FIGS. 4A to 4D, it should be readily appreciated that at injection, after scavenging has started, the injected hydrogen fuel will expand and create a pulse in the intake ports and plenum. This pulse will propagate and add to the scavenging effect and also increase the pressure in the cylinder. However, the pulse is limited from travelling backwards in the air intake duct (air intake system) by the positive displacement device 23 acting like a check valve and also momentarily adding boost pressure during the pulse.

Moreover, depending on when in time the intake valves 37, 47 are closed, the ICE system 10 is operable to expand the combustible gas during a longer time period in the combustion chambers 30, 40 in comparison to the duration of the compression phase. In this manner, there is provided a built-in Miller or Atkinson cycle function that increases efficiency.

Further, since the two-stroke cycle of the ICE system 10 provides for twice as many work cycles as a conventional four-stroke ICE per revolution, the ICE system 10 allows for operating in a lean condition where it is not possible to get as much power per work cycle as a conventional diesel ICE. I.e. while hydrogen gas and other gases need to be run lean for emission purposes (NOx control), the two-stroke cycle allows for creating twice as many work cycles at the same ICE rpm.

In operation of the ICE system 10, the ICE system 10 may perform the following method:

In a step S10, when a piston is travelling down from TDC to BDC in one of the cylinders during expansion of the combustibles and a corresponding exhaust port is uncovered, the effective work stroke is ended, and the gases are exhausted through the exhaust port. Subsequently, in a step S20, the intake valve(s) of one of the cylinder opens and the cylinder is purged by incoming air fed by the aforementioned boosting system (e.g. by the turbocharger arrangement 70 and the positive displacement device 23). At this stage there is no fuel present in the boost mass or the cylinder.

Then, in step S30, the piston reaches BDC. Thereafter, in step S40, the piston starts to move up towards its TDC and the piston eventually covers the exhaust port again. At this position, the fuel injector arrangement is operated to inject e.g. hydrogen fuel. The hydrogen fuel is injected into the intake port, creating the pressure pulse from the injected hydrogen fuel. As such, the ICE system 10 is operated to start injecting hydrogen gas into the air stream in the plenum 25, thus feeding air and hydrogen into the cylinder. The injection starts after the intake valve has opened just after the initial scavenging (cylinder purge) and ends before the intake valve closes which provides an essentially intake tract free of combustible gas.

Initial scavenging of the cylinder (purging) is the time between IVO and start of hydrogen gas injection.

In step S50, the piston continues to travel up (about halfway) through the stroke and the intake valves closes.

In step S60, the piston travels to just before TDC, TDC or just after TDC (i.e. close to TDC).

Subsequently, in step S70, the ignition source (e.g. a spark plug) ignites the homogenous air/hydrogen mix in the cylinder(s).

Then, in step S80, the piston is forced down in the work stroke (expansion).

Thereafter, in step S90, the cycle repeats from above steps S10 to S80.

As should be readily appreciated from the above, the operation of purging, scavenging and subsequent fuel injection operation, creating a boost pulse, as well as the ending of fuel injection where hydrogen (H2)/air mixture is pushed into the cylinder allows for emptying the plenum 25, while the positive displacement device 23 is operated to push in fresh air in the plenum 25. In this manner, the arrangement and configuration of the ICE system 10 provides for avoiding, or at least reducing the risk of having hydrogen mixture in the plenum 25, hence, reducing the risk for backfire.

It should be noted that if the intake valves are opened all at the same time, a flow effect in the whole cross section area of the cylinder can be obtained so that the cylinder is filled homogenously from top to bottom, driving out the exhaust gases so that low mixing between the fresh charge air and the warm exhaust combustibles is obtained. This may be useful so as to reduce the mixture temperature and residuals in preparation of the mixture. The intake valves are then completely closed when the piston is halfway up in the cylinder which reduces the risk of a backfire.

It should be noted that the above presentation of the ICE system 10 should also be regarded as disclosing a method for controlling the ICE system 10, for instance using the controller 90.

The combustion chambers can be designed in several different manners and may be any one of a flat, hemispherical or pent roof design with only intake valves. It may be beneficial to cover a large area of the combustion chamber with valves so that the cylinder filling can be made in an efficient manner.

All moving parts in the ICE 20 may generally be lubricated by means of conventional pressure lubrication. Other options are also possible.

The positive displacement device 23 and the plenum 25 of the air intake duct 22 are generally considered to be the cold components and may be made from an aluminum alloy. The air intake duct 22 may typically be fastened to the cylinder heads that may be warmer, which is made of cast iron or steel. This may minimize the risk of hydrogen embrittlement since no gas containing hydrogen comes into contact with any iron or steel that is colder than 150 degrees C., which is the threshold when hydrogen embrittlement is considered to occur.

The ICE system 10 can be cooled in several different ways. By way of example, the ICE system 10 comprises a controlled low temperature coolant circuit for temperature control of the CAC (Compressed Air Cooler) and/or the EGR cooler. By this, the condensation level of the returned water from the combustibles (H2 produce H2O when combusted) is controlled. In addition, the ICE system 10 may comprise water injection system. The water injection system can be arranged and configured to inject water in the intake port(s), directly into the cylinder, or prior to the intake positive displacement device 23. Moreover, the condensed water from the exhaust can be used for water injection. If it is injected prior to the positive displacement device, there is a benefit of mixing and evaporation/cooling in the roots blower. The water injection as a temperature reduction medium for the boost air after the positive displacement device is an advantage in examples where the positive displacement device is used for compression work for additional boosting.

It should be noted that the ICE system 10 may not be restricted to a system with one single pair of cylinders 30, 40, but can also be implemented in an ICE system comprising four cylinders, six cylinders etc. Hence, the ICE system 10 may have a minimum of two cylinders, but multiples of two cylinders may likewise be possible.

In ICE systems 10 further comprising additional pairs of neighboring cylinders, each arrangement of a pair of neighboring cylinders has a corresponding air intake duct with a corresponding positive displacement device.

In other words, a four-cylinders ICE will have two positive displacement devices and a six-cylinder ICE will have three positive displacement devices. Such ICE system may also use a positive displacement device with a plurality of separated sections, wherein each section is provided to cooperated with a given pair of cylinders. In this arrangement, the flow of fluid (air) to each pair of cylinders should be separated from each other. The cylinder pairs can be arranged spaced-apart so as to allow for ignition of fuel for three cylinders at once (flat crank) or arranged evenly offset from each other for an evenly spread firing order. In this way, it becomes possible to charge one cylinder in the pair at the time without creating unwanted pulsation since one cylinder is in its intake stroke while the other one is in its work stroke.

Moreover, the present disclosure may be exemplified by any one of the below examples.

Example 1: The ICE system comprises a two-stroke ICE operable on a fuel, the ICE having at least one cylinder with a cylinder wall and further a reciprocating piston moveable in an axial direction within the cylinder between a bottom dead center BDC and a top dead center TDC, the piston having a piston skirt 70 extending in the axial direction. Moreover, the piston comprises an axial upper part 74 with a top end 33 intended to form part of a combustion chamber. Further the piston comprises an axial lower part 75. The at least one cylinder at least partly defining the combustion chamber 32 with the top end of the piston. The at least one cylinder comprises at least one intake port 35 arranged at a top end 36 of the at least one cylinder and in fluid communication with the combustion chamber, and further an exhaust port 38 arranged axially distal from the top end of the at least one cylinder, allowing the at least one intake port and the exhaust port to be fluidly separated by the piston, and wherein the axial upper part 74 of the piston comprises a number of compression rings 71, 72 for sealing at the combustion chamber and the axial lower part 75 comprises at least one compression ring 78 configured to seal along a region 73 of the cylinder wall axially below the exhaust port, so as to reduce leakage of blow by gases from the combustion chamber into a crankcase volume part of the ICE.

Example 2: The ICE system of example 1, wherein the at least one compression ring 78 of the axial lower part and a compression ring of the number of compression rings of the axial upper part are arranged on the piston to provide an intermediate ring land 79 where blow by gases can be trapped and evacuated through the exhaust port.

Example 3: ICE system according to example 1 or example 2, wherein the at least one compression ring 78 of the axial lower part is arranged on the piston such that a position of the at least one compression ring 78 is axially below the exhaust port at the TDC of the piston.

Example 4: ICE system according to any one of the preceding examples, wherein the number of compression rings of the axial upper part is arranged on the piston such that a position of the number of compression rings is axially below the exhaust port at the BDC of the piston.

Example 5: ICE system according to any one of the preceding examples, wherein the number of compression rings of the axial upper part comprises at least two compression rings.

Example 6: ICE system according to any one of the preceding examples, wherein the axial lower part of the piston comprises an oil control ring 76 arranged axially below the compression ring.

Example 7: ICE system according to any one of the preceding examples, wherein any one of the compression rings is defined by a homogenous rectangular cross-section or a tapered cross-section.

Example 8: ICE system according to any one of the preceding examples 1 to 6, wherein the at least one compression ring of the axial lower part is a Napier-type compression ring.

Example 9: ICE system according to any one of the preceding examples, wherein the at least one compression ring of the axial lower part is arranged in a groove 77 extending circumferentially around the piston skirt.

Example 10: ICE system according to any one of the preceding examples, wherein the ICE system is a spark-ignition ICE system, the at least one cylinder having an ignition source 34 arranged in the combustion chamber.

Example 11: ICE system according to any one of the preceding examples, wherein the ICE system comprises an injector arrangement for injecting fuel, the injector arrangement being arranged in the combustion chamber.

Example 12: ICE system according to any one of the preceding examples, wherein the flow of intake-gas though the at least one intake port is controllable by an intake control valve 37.

Example 13: ICE system according to any one of the preceding examples, wherein ICE system according to any one of the preceding claims, wherein the at least one cylinder is a first cylinder and the piston is a first piston, and the ICE further having a second cylinder forming a pair of cylinders with the first cylinder, the second cylinder accommodating a corresponding reciprocating second piston 41 operable between a bottom dead center and a top dead center, and further at least partly defining a second combustion chamber 42 with a top end 43 of the second piston, wherein the second cylinder further comprises a corresponding ignition source 44 arranged in the second combustion chamber, at least one corresponding intake port 45 arranged at a top end 46 of the second cylinder and in fluid communication with the second combustion chamber, and further a corresponding exhaust port 48 arranged axially distal from the top end of the second cylinder, allowing the at least one corresponding intake port and the corresponding exhaust port to be fluidly separated by the piston.

Example 14: ICE system according to example 13, wherein the first and second cylinders are separated from each other with a crank angle of 180 degrees.

Example 15: ICE system according to example 13 or example 14, wherein, ICE system further comprising an air intake duct 22 having a positive displacement device 23 configured to receive and feed intake air to the at least one pair of cylinders, the positive displacement device further being arranged in the air intake duct to separate an upstream intake tract 24 from a downstream plenum 25 of the air intake duct, the downstream plenum being in fluid communication with each one of the first and second cylinders of the at least one pair of cylinders.

Example 16: ICE system according to example 15, wherein the intake control valve of the first cylinder is controllable in correlation with the movement of the first piston and the intake control valve of the second cylinder is controllable in correlation with the movement of the second piston such that fluid communication between the respective combustion chambers and the downstream plenum being selectively opened and closed during a crank shaft revolution of the ICE.

Example 17: ICE system according to example 15 or example 16, wherein the plenum comprises an air inlet in fluid communication with the positive displacement device and a plurality of outlets configured to be in fluid communication with the intake ports of the first and second cylinders.

Example 18: ICE system according to any one of the preceding examples 13 to 17, wherein the ICE system comprises a common crankcase housing 65 for the pair of cylinders, or, the ICE system comprises multiple set of pair of cylinders and the ICE system comprises a common crankcase housing for all cylinders of the ICE.

Example 19: ICE system according to any one of the preceding examples, wherein the ICE system is a hydrogen ICE system configured to operate on a gaseous fuel containing a hydrogen-based gaseous fuel.

Example 20: A vehicle comprising an internal combustion engine system according to any one of the examples 1 to 19.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows.

Also, the term “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A hydrogen spark-ignition internal combustion engine (ICE) system for a vehicle, the ICE system comprising:
a two-stroke ICE operable on a hydrogen-based gaseous fuel,
the ICE having at least one cylinder with a cylinder wall and further a reciprocating piston moveable in an axial direction within the cylinder between a bottom dead centre (BDC) and a top dead centre (TDC), the piston extending in the axial direction and having an axial upper part with a top end intended to form part of a combustion chamber, and further an axial lower part,
the at least one cylinder at least partly defining the combustion chamber with the top end of the piston, the at least one cylinder having an ignition source arranged in the combustion chamber,
wherein the at least one cylinder comprises at least one intake port arranged at a top end of the at least one cylinder and in fluid communication with the combustion chamber,
and further an exhaust port arranged axially distal from the top end of the at least one cylinder, allowing the at least one intake port and the exhaust port to be fluidly separated by the piston, and
wherein the axial upper part of the piston comprises a number of compression rings for sealing of the combustion chamber, and the axial lower part of the piston comprises at least one compression ring configured to seal along a region of the cylinder wall axially below the exhaust port, so as to reduce leakage of blow by gases from the combustion chamber into a crankcase volume part of the ICE.

2. The ICE system according to claim 1, wherein the at least one compression ring of the axial lower part and a compression ring of the number of compression rings of the axial upper part are arranged on the piston to provide an intermediate ring land where blow by gases can be trapped and evacuated through the exhaust port.

3. The ICE system according to claim 1, wherein the at least one compression ring of the axial lower part is arranged on the piston such that a position of the at least one compression ring is axially below the exhaust port at the TDC of the piston.

4. The ICE system according to claim 1, wherein the number of compression rings of the axial upper part is arranged on the piston such that a position of the number of compression rings is axially below the exhaust port at the BDC of the piston.

5. The ICE system according to claim 1, wherein the number of compression rings of the axial upper part comprises at least two compression rings.

6. The ICE system according to claim 1, wherein the axial lower part of the piston comprises an oil control ring arranged axially below the at least one compression ring at the axial lower part of the piston.

7. The ICE system according to claim 1, wherein any one of the compression rings of the at least one compression ring and the number of compression rings is defined by a homogenous rectangular cross-section or a tapered cross-section.

8. The ICE system according to claim 1, wherein the at least one compression ring of the axial lower part is a Napier-type compression ring.

9. The ICE system according to claim 1, wherein the ICE system comprises an injector arrangement for injecting fuel, the injector arrangement being arranged in the combustion chamber.

10. The ICE system according to claim 1, wherein a flow of intake gas through the at least one intake port is controllable by an intake control valve.

11. The ICE system according to claim 1, wherein the at least one cylinder is a first cylinder and the piston is a first piston, and the ICE further having a second cylinder forming a pair of cylinders with the first cylinder, the second cylinder accommodating a corresponding reciprocating second piston operable between a bottom dead centre and a top dead centre, and further at least partly defining a second combustion chamber with a top end of the second piston, wherein the second cylinder further comprises a corresponding ignition source arranged in the second combustion chamber, at least one corresponding intake port arranged at a top end of the second cylinder and in fluid communication with the second combustion chamber, and further a corresponding exhaust port arranged axially distal from the top end of the second cylinder, allowing the at least one corresponding intake port and the corresponding exhaust port to be fluidly separated by the second piston.

12. The ICE system according to claim 11, wherein the first and second cylinders are separated from each other with a crank angle of 180 degrees.

13. The ICE system according to claim 11, further comprising an air intake duct having a positive displacement device configured to receive and feed intake air to the pair of cylinders, the positive displacement device further being arranged in the air intake duct to separate an upstream intake tract from a downstream plenum of the air intake duct, the downstream plenum being in fluid communication with each one of the first and second cylinders of the pair of cylinders.

14. The ICE system according to claim 10, wherein the intake control valve of the first cylinder is controllable in correlation with movement of the first piston and the intake control valve of the second cylinder is controllable in correlation with the movement of the second piston such that fluid communication between the respective combustion chambers and the downstream plenum being selectively opened and closed during a crank shaft revolution of the ICE.

15. The ICE system according to claim 11, wherein the ICE system comprises a common crankcase housing for the pair of cylinders, or, the ICE system comprises multiple set of pair of cylinders and the ICE system comprises a common crankcase housing for all cylinders of the ICE.

16. A vehicle comprising an internal combustion engine system according to claim 1.
